(19) United States
(12) Patent Application Publication
(10) Pub. No.: US 2026/0110264 A1
(43) Pub. Date: Apr. 23, 2026

(54) SYSTEMS, ASSEMBLIES, AND METHODS TO ENHANCE INTAKE AIR FLOW TO A GAS TURBINE ENGINE OF A HYDRAULIC FRACTURING UNIT

(71) Applicant: BJ Energy Solutions, LLC, The Woodlands, TX (US)

(72) Inventors: Tony YEUNG, The Woodlands, TX (US); Ricardo RODRIGUEZ-RAMON, The Woodlands, TX (US)

(73) Assignee: BJ Energy Solutions, LLC, The Woodlands, TX (US)

(21) Appl. No.: 19/225,977

(22) Filed: Jun. 2, 2025

Related U.S. Application Data
(63) Continuation of application No. 17/989,601, filed on Nov. 17, 2022, now Pat. No. 12,338,772.
Application No. 17/989,601 is a continuation-in-part of application No. 17/954,118, filed on Sep. 27, 2022, now Pat. No. 11,598,263.
Application No. 17/954,118 is a continuation of application No. 17/403,373, filed on Aug. 16, 2021, now Pat. No. 11,560,845.
Application No. 17/403,373 is a continuation of application No. 17/326,711, filed on May 21, 2021, now Pat. No. 11,156,159.
Application No. 17/326,711 is a continuation of application No. 17/213,802, filed on Mar. 26, 2021, now Pat. No. 11,060,455.
Application No. 17/213,802 is a continuation of application No. 16/948,289, filed on Sep. 11, 2020, now Pat. No. 11,002,189.
(60) Provisional application No. 62/900,291, filed on Sep. 13, 2019.
(60) Provisional application No. 62/704,565, filed on May 15, 2020.

(51) Int. Cl. F02C 7/052; B01D 46/42; B01D 46/58; F02C 6/00; F02C 7/042; F02C 7/143

(52) U.S. Cl. CPC F02C 7/052; B01D 46/4263; B01D 46/58; F02C 6/00; F02C 7/042; F02C 7/143; B01D 2279/60

(57) ABSTRACT

Systems, assemblies, and methods to enhance the efficiency of operation of a gas turbine engine may include a turbine housing positioned to at least partially enclose the gas turbine engine, and a filtration assembly connected to the turbine housing to supply at least partially filtered intake air to an inlet assembly associated with the gas turbine engine. The filtration assembly may include a pre-cleaner including one or more inertial separators configured to separate a first portion of particles and/or liquid from ambient air supplied to the gas turbine engine, thereby to provide at least partially filtered intake air, and one or more filters positioned downstream of the pre-cleaner to separate a second portion of the particles and/or liquid from the at least partially filtered intake air.

### PRIORITY CLAIMS

This application is a continuation of U.S. Non-Provisional application Ser. No. 17/989,601, filed Nov. 17, 2022, titled “SYSTEMS, ASSEMBLIES, AND METHODS TO ENHANCE INTAKE AIR FLOW TO A GAS TURBINE ENGINE OF A HYDRAULIC FRACTURING UNIT”, which is a continuation-in-part of U.S. Non-Provisional application Ser. No. 17/954,118, filed Sep. 27, 2022, titled “MOBILE GAS TURBINE INLET AIR CONDITIONING SYSTEM AND ASSOCIATED METHODS,” which is a continuation of U.S. Non-Provisional application Ser. No. 17/403,373, filed Aug. 16, 2021, titled “MOBILE GAS TURBINE INLET AIR CONDITIONING SYSTEM AND ASSOCIATED METHODS,” which is a continuation of U.S. Non-Provisional application Ser. No. 17/326,711, filed May 21, 2021, titled “MOBILE GAS TURBINE INLET AIR CONDITIONING SYSTEM AND ASSOCIATED METHODS,” now U.S. Pat. No. 11,156,159, issued Oct. 26, 2021, which is a continuation U.S. Non-Provisional application Ser. No. 17/213,802, filed Mar. 26, 2021, titled “MOBILE GAS TURBINE INLET AIR CONDITIONING SYSTEM AND ASSOCIATED METHODS,” now U.S. Pat. No. 11,060,455, issued Jul. 13, 2021, which is a continuation of U.S. Non-Provisional application Ser. No. 16/948,289, filed Sep. 11, 2020, titled “MOBILE GAS TURBINE INLET AIR CONDITIONING SYSTEM AND ASSOCIATED METHODS,” now U.S. Pat. No. 11,002,189, issued May 11, 2021, which claims priority to and the benefit of U.S. Provisional Application No. 62/704,565, filed May 15, 2020, titled “MOBILE GAS TURBINE INLET AIR CONDITIONING SYSTEM AND ASSOCIATED METHODS,” and U.S. Provisional Application No. 62/900,291, filed Sep. 13, 2019, titled “MOBILE GAS TURBINE INLET AIR CONDITIONING SYSTEM,” the disclosures of which are incorporated herein by reference in their entireties.

### TECHNICAL FIELD

The present disclosure relates to systems, assemblies, and methods for enhancing intake air flow to a gas turbine engine and, more particularly, to systems, assemblies, and methods for enhancing intake air flow to a gas turbine engine of a hydraulic fracturing unit.

### BACKGROUND

Hydraulic fracturing is an oilfield operation that stimulates production of hydrocarbons, such that the hydrocarbons may more easily or readily flow from a subsurface formation to a well. For example, a fracturing system may be configured to fracture a formation by pumping a fracturing fluid into a well at high pressure and high flow rates. Some fracturing fluids may take the form of a slurry including water, proppants, and/or other additives, such as thickening agents and/or gels. The slurry may be forced via one or more pumps into the formation at rates faster than can be accepted by the existing pores, fractures, faults, or other spaces within the formation. As a result, pressure builds rapidly to the point where the formation may fail and may begin to fracture. By continuing to pump the fracturing fluid into the formation, existing fractures in the formation are caused to expand and extend in directions farther away from a well bore, thereby creating flow paths to the well bore. The proppants may serve to prevent the expanded fractures from closing when pumping of the fracturing fluid is ceased or may reduce the extent to which the expanded fractures contract when pumping of the fracturing fluid is ceased. Once the formation is fractured, large quantities of the injected fracturing fluid are allowed to flow out of the well, and the production stream of hydrocarbons may be obtained from the formation.

Prime movers may be used to supply power to hydraulic fracturing pumps for pumping the fracturing fluid into the formation. For example, a plurality of gas turbine engines may each be mechanically connected to a corresponding hydraulic fracturing pump via a transmission and operated to drive the hydraulic fracturing pump. The gas turbine engine, hydraulic fracturing pump, transmission, and auxiliary components associated with the gas turbine engine, hydraulic fracturing pump, and transmission may be connected to a common platform or trailer for transportation and set-up as a hydraulic fracturing unit at the site of a fracturing operation, which may include up to a dozen or more of such hydraulic fracturing units operating together to perform the fracturing operation.

The performance of a gas turbine engine is dependent on the conditions under which the gas turbine engine operates. For example, ambient air pressure and temperature are large factors in the output of the gas turbine engine, with low ambient air pressure and high ambient temperature reducing the maximum output of the gas turbine engine. Low ambient pressure and/or high ambient temperature reduce the density of air, which reduces the mass flow of the air supplied to the intake of the gas turbine engine for combustion, which results in a lower power output. Some environments in which hydraulic fracturing operations occur are prone to low ambient pressure, for example, at higher elevations, and/or higher temperatures, for example, in hot climates. In addition, gas turbine engines are subject to damage by particulates in air supplied to the intake. Thus, in dusty environments, such as at many well sites, the air must be filtered before entering the intake of the gas turbine engine. However, filtration may reduce the pressure of air supplied to the intake, particularly as the filter medium of the filter becomes obstructed by filtered particulates with use. Reduced power output of the gas turbine engines reduces the pressure and/or flow rate provided by the corresponding hydraulic fracturing pumps of the hydraulic fracturing units. Thus, the effectiveness of a hydraulic fracturing operation may be compromised by reduced power output of the gas turbine engines of the hydraulic fracturing operation.

Accordingly, Applicant has recognized a need for systems, assemblies, and methods that provide enhanced air flow to the intake of a gas turbine engine for hydraulic fracturing operations. The present disclosure may address one or more of the above-referenced drawbacks, as well as other possible drawbacks.

### SUMMARY

As referenced above, it may be desirable to provide systems, assemblies, methods that provide enhanced air flow to the intake of a gas turbine engine for hydraulic fracturing operations. For example, as noted above, low ambient pressure and/or high ambient temperature may reduce the density of air, which reduces the mass flow of the air supplied to the intake of the gas turbine engine for combustion, which results in a lower power output. In addition, particles and/or liquid in air supplied to the intake of a gas turbine engines may damage the gas turbine engine. Thus, in dusty environments, such as at many well sites, the air may be filtered before entering the intake of the gas turbine engine to reduce the likelihood of damage to the gas turbine engine. Filtration of the air, however, may reduce the pressure of air supplied to the intake, particularly as the filter medium of the filter becomes obstructed by filtered particulates with use. The gas turbine engine may not be capable of achieving its optimum power output under such conditions, and further, as air flow through the filter media becomes impeded by a build-up of particles and/or liquid, suction resulting from operation of the gas turbine engine may cause the filter to collapse, potentially resulting in damage to the gas turbine engine and excessive downtime for maintenance. Reduced power output of the gas turbine engines reduces the pressure and/or flow rate provided by the corresponding hydraulic fracturing pumps of the hydraulic fracturing units. Thus, the effectiveness of a hydraulic fracturing operation may be compromised by reduced power output of the gas turbine engines of the hydraulic fracturing operation.

The present disclosure generally is directed to assemblies and methods to enhance the efficiency of operation of gas turbine engines, which may be connected to, for example, one or more hydraulic fracturing pumps to pump hydraulic fracturing fluid into wellheads. For example, in some embodiments, an intake air treatment assembly may be provided to enhance the efficiency of operation of a gas turbine engine including an inlet assembly positioned to supply intake air to the gas turbine engine. The intake air treatment assembly may include a filtration assembly including one or more pre-cleaners to receive ambient air drawn into the filtration assembly via operation of the gas turbine engine, and the one or more pre-cleaners may include one or more inertial separators configured to separate particles and/or liquid from the ambient air to provide at least partially filtered intake air prior to the ambient air reaching the inlet of the gas turbine engine. The pre-cleaners, in at least some embodiments, may serve to reduce particles and/or liquid from reaching one or more filters, which may reduce the rate at which the one or more filters need to be services or replaced, thereby reducing maintenance and downtime associated with the one or more filters.

According to some embodiments, a pre-cleaner to enhance the efficiency of separation of particles and/or fluid from intake air supplied to a gas turbine engine, may include a first panel positioned to face outward from a filtration assembly and a second panel opposite the first panel. The first panel and the second panel may at least partially define a separator cavity therebetween. The pre-cleaner further may include one or more inertial separators extending between the first panel and the second panel. The one or more inertial separators may be positioned to separate a portion of particles and/or liquid from ambient air, thereby to provide at least partially filtered intake air for supply to the gas turbine engine. The one or more inertial separators may include an air flow tube having a proximal end connected to the first panel, may extend toward the second panel, and may terminate at a distal end. The air flow tube may define an interior cross-sectional area. The one or more inertial separators further may include a diverter connected to the air flow tube and positioned to cause ambient air entering the air flow tube to swirl as the ambient air flows from the proximal end of the air flow tube to the distal end of the air flow tube. The one or more inertial separators also may include a separator tube connected to the second panel and extending from the second panel toward the distal end of the air flow tube. The separator tube may have an exterior cross-sectional area smaller than the interior cross-sectional area of the air flow tube.

According to some embodiments, an intake air treatment assembly to enhance the efficiency of operation of a gas turbine engine including an inlet assembly positioned to supply intake air to the gas turbine engine, may include a turbine housing configured to at least partially enclose the gas turbine engine and the inlet assembly. The turbine housing may be positioned to facilitate supply of intake air to the inlet assembly of the gas turbine engine. The intake air treatment assembly may further include a filtration assembly connected to the turbine housing and positioned to provide a flow path to supply at least partially filtered intake air to the inlet assembly of the gas turbine engine. The filtration assembly may include a pre-cleaner positioned to receive ambient air drawn into the filtration assembly via operation of the gas turbine engine and including one or more inertial separators configured to separate a first portion of particles and/or liquid from the ambient air, thereby to provide at least partially filtered intake air. The filtration assembly further may include one or more filters positioned in the flow path downstream of the pre-cleaner and configured to separate a second portion of the particles and/or liquid from the at least partially filtered intake air, thereby to provide the at least partially filtered intake air to the inlet assembly of the gas turbine engine.

According to some embodiments, a hydraulic fracturing unit to enhance flow of fracturing fluid into a wellhead during a high-pressure fracturing operation may include a chassis having a longitudinal chassis axis and a width perpendicular to the longitudinal chassis axis. The hydraulic fracturing unit further may include a gas turbine engine supported by the chassis, and an inlet assembly connected to the gas turbine engine to supply intake air to the gas turbine engine. The hydraulic fracturing unit also may include a hydraulic fracturing pump connected to the gas turbine engine, and an intake air treatment assembly associated with the intake assembly to enhance the efficiency of operation of the gas turbine engine. The intake air treatment assembly may include a turbine housing at least partially enclosing the gas turbine engine and the inlet assembly, and positioned to facilitate supply of intake air to the inlet assembly of the gas turbine engine. The hydraulic fracturing unit further may include a filtration assembly connected to the turbine housing and positioned to provide a flow path to supply at least partially filtered intake air to the inlet assembly. The filtration assembly may include a pre-cleaner positioned to receive ambient air drawn into the filtration assembly via operation of the gas turbine engine and including one or more inertial separators configured to separate a first portion of particles and/or liquid from the ambient air, thereby to provide at least partially filtered intake air. The filtration assembly also may include one or more filters positioned in the flow path downstream of the pre-cleaner and configured to separate a second portion of the particles and/or liquid from the at least partially filtered intake air, thereby to provide the at least partially filtered intake air to the inlet assembly of the gas turbine engine.

According to some embodiments, a method to enhance the efficiency of operation of a gas turbine engine may include causing ambient air to flow toward an inlet assembly connected to the gas turbine engine, and passing the ambient air through one or more pre-cleaners to cause the ambient air to swirl and separate a first portion of particles and/or liquid from the ambient air, thereby to provide at least partially filtered intake air. The method further may include passing the at least partially filtered intake air through one or more filters to separate a second portion of the particles and/or liquid from the at least partially filtered intake air, thereby to provide further filtered intake air. The method also may include supplying the further filtered intake air to the intake assembly.

Still other aspects and advantages of these exemplary embodiments and other embodiments, are discussed in detail herein. Moreover, it is to be understood that both the foregoing information and the following detailed description provide merely illustrative examples of various aspects and embodiments, and are intended to provide an overview or framework for understanding the nature and character of the claimed aspects and embodiments. Accordingly, these and other objects, along with advantages and features of the present disclosure, will become apparent through reference to the following description and the accompanying drawings. Furthermore, it is to be understood that the features of the various embodiments described herein are not mutually exclusive and may exist in various combinations and permutations.

### BRIEF DESCRIPTION OF THE DRAWINGS

The accompanying drawings, which are included to provide a further understanding of the embodiments of the present disclosure, are incorporated in and constitute a part of this specification, illustrate embodiments of the present disclosure, and together with the detailed description, serve to explain principles of the embodiments discussed herein. No attempt is made to show structural details of this disclosure in more detail than can be necessary for a fundamental understanding of the embodiments discussed herein and the various ways in which they can be practiced. According to common practice, the various features of the drawings discussed below are not necessarily drawn to scale. Dimensions of various features and elements in the drawings can be expanded or reduced to more clearly illustrate embodiments of the disclosure.

FIG. 1 schematically illustrates an example hydraulic fracturing system including a plurality of example hydraulic fracturing units, according to embodiments of the disclosure.

FIG. 2 is a schematic perspective view of an example hydraulic fracturing unit, according to embodiments of the disclosure.

FIG. 3A is a schematic partial side section view of an example hydraulic fracturing unit, according to embodiments of the disclosure.

FIG. 3B is a schematic detailed partial side section view of an example intake air treatment assembly of the example hydraulic fracturing unit shown in FIG. 3A, according to embodiments of the disclosure.

FIG. 4A is a schematic perspective view of an example intake air treatment assembly, according to embodiments of the disclosure.

FIG. 4B is a schematic top view of an example intake air treatment assembly showing an example flow path, according to embodiments of the disclosure.

FIG. 4C is a schematic top view of another example intake air treatment assembly showing another example flow path, according to embodiments of the disclosure.

FIG. 4D is a schematic top view of an example intake air treatment assembly including example sound attenuation baffles, according to embodiments of the disclosure.

FIG. 4E is a schematic top view of another example intake air treatment assembly not including sound attenuation baffles, according to embodiments of the disclosure.

FIG. 5A is a schematic perspective view of an example pre-cleaner viewed from an exterior side, according to embodiments of the disclosure.

FIG. 5B is a schematic perspective partial section view of the example pre-cleaner shown in FIG. 5A, according to embodiments of the disclosure.

FIG. 5C is a schematic side view of the example pre-cleaner shown in FIG. 5A viewed from the exterior side, according to embodiments of the disclosure.

FIG. 5D is a schematic bottom view of the example pre-cleaner shown in FIG. 5A, according to embodiments of the disclosure.

FIG. 5E is a schematic end view of the example pre-cleaner shown in FIG. 5A, according to embodiments of the disclosure.

FIG. 5F is a schematic partial side section view of an example inertial separator of the example pre-cleaner shown in FIG. 5A, according to embodiments of the disclosure.

FIG. 6 is a graph showing backpressure as a function of air velocity through an example inertial separator, according to embodiments of the disclosure.

FIG. 7 is a graph showing inertial separator efficiency as a function of flow rate through an example inertial separator for example coarse particles and example fine particles, according to embodiments of the disclosure.

FIG. 8 is a schematic diagram of an embodiment of an intake air treatment assembly for increasing the efficiency of a gas turbine engine, according to embodiments of the disclosure.

FIG. 9 shows an exemplary system setup of an air conditioning system for a gas turbine engine, according to embodiments of the disclosure.

FIG. 10 illustrates example performance loss of the gas turbine engine with increased temperature, according to embodiments of the disclosure.

FIG. 11 illustrates, in table form, ambient air properties at different elevations and temperatures, according to embodiments of the disclosure.

FIG. 12 is a schematic diagram of an example electrical system for operating an example intake air treatment assembly, according to embodiments of the disclosure.

FIG. 13 is a schematic diagram of an example hydraulic system for operating an example intake air treatment system, according to embodiments of the disclosure.

### DETAILED DESCRIPTION

The drawings include like numerals to indicate like parts throughout the several views, the following description is provided as an enabling teaching of exemplary embodiments, and those skilled in the relevant art will recognize that many changes may be made to the embodiments described. It also will be apparent that some of the desired benefits of the embodiments described can be obtained by selecting some of the features of the embodiments without utilizing other features. Accordingly, those skilled in the art will recognize that many modifications and adaptations to the embodiments described are possible and may even be desirable in certain circumstances. Thus, the following description is provided as illustrative of the principles of the embodiments and not in limitation thereof.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to,” unless otherwise stated. Thus, the use of such terms is meant to encompass the items listed thereafter, and equivalents thereof, as well as additional items. The transitional phrases “consisting of” and “consisting essentially of,” when present, are closed or semi-closed transitional phrases, respectively, with respect to any claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish claim elements.

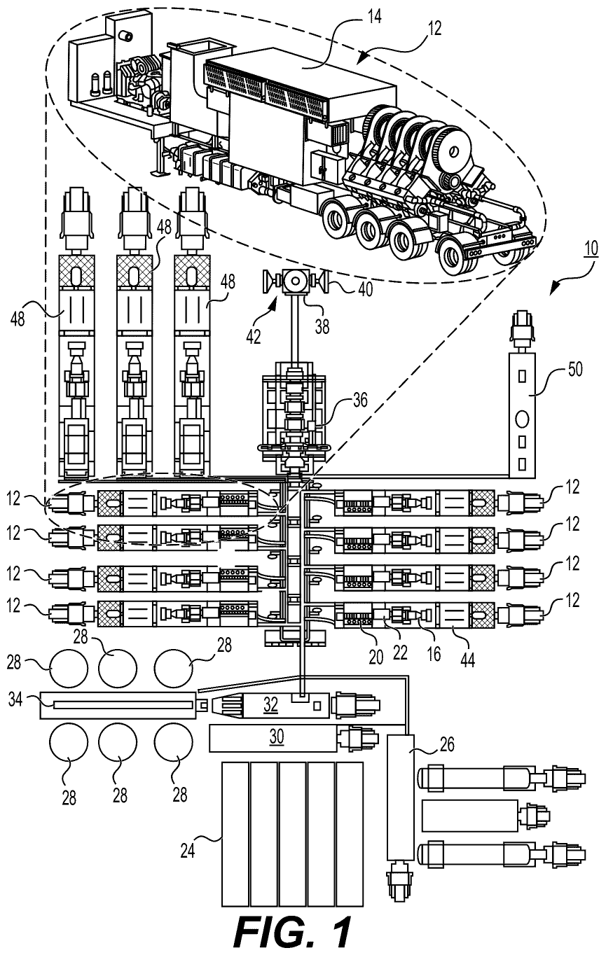

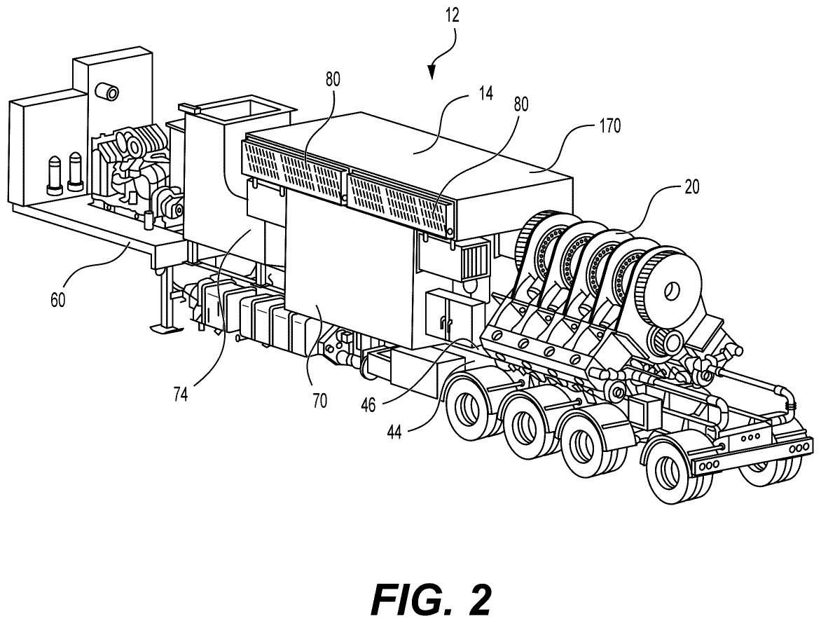

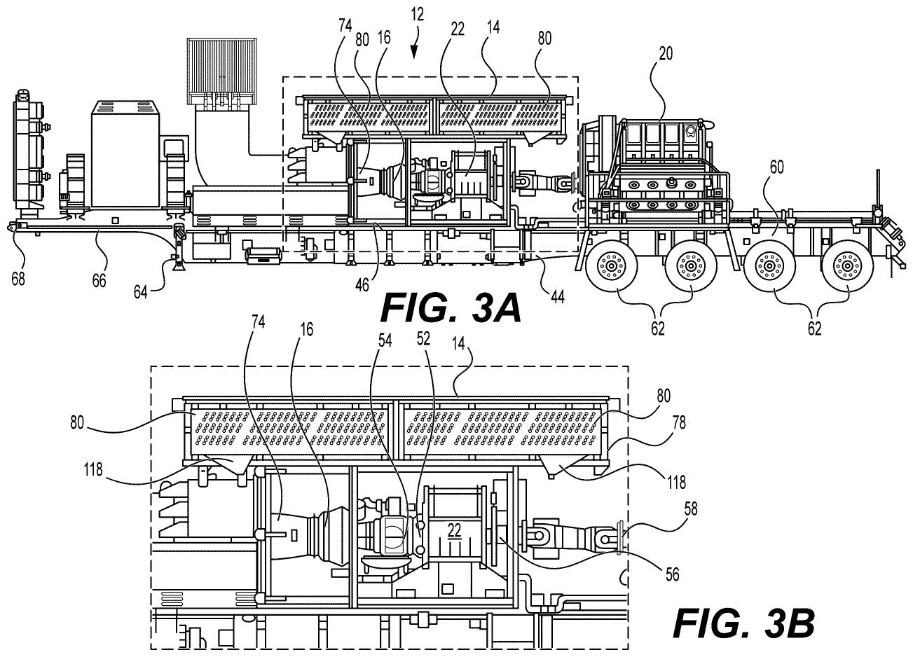

FIG. 1 schematically illustrates a top view of an example hydraulic fracturing system 10 including a plurality of hydraulic fracturing units 12, according to embodiments of the disclosure. FIG. 2 is a schematic perspective view of an example hydraulic fracturing unit 12, according to embodiments of the disclosure. FIG. 3A is a schematic partial side section view of an example hydraulic fracturing unit 12, and FIG. 3B is a detailed partial side section view of an example intake air treatment assembly 14 of the example hydraulic fracturing unit 12 shown in FIG. 3A, according to embodiments of the disclosure. As explained herein, the intake air treatment assembly 14, in some embodiments, may be configured to enhance the efficiency of operation of a prime mover, such as a gas turbine engine (GTE) 16, including an inlet assembly 18 positioned to supply intake air to the GTE 16.

As shown in FIGS. 3A and 3B, in some embodiments, one or more of the hydraulic fracturing units 12 may include a hydraulic fracturing pump 20 driven by a GTE 16. In some embodiments, the prime mover may be a type of internal combustion engine other than a GTE, such as a reciprocating-piston engine (e.g., a diesel engine). In some embodiments, each of the hydraulic fracturing units 12 may include a directly-driven turbine (DDT) hydraulic fracturing pump 20, in which the hydraulic fracturing pump 20 is connected to one or more GTEs 16 that supply power to the respective hydraulic fracturing pump 20 for supplying fracturing fluid at high pressure and high flow rates to a formation. For example, the GTE 16 may be connected to a respective hydraulic fracturing pump 20 via a transmission 22 (e.g., a reduction gearbox) connected to a drive shaft, which, in turn, is connected to a driveshaft or input flange of a respective hydraulic fracturing pump 20, which may be a reciprocating hydraulic fracturing pump. Other types of engine-to-pump arrangements are contemplated as will be understood by those skilled in the art.

In some embodiments, one or more of the GTEs 16 may be a dual-fuel or bi-fuel GTE, for example, capable of being operated using of two or more different types of fuel, such as natural gas and diesel fuel, although other types of fuel are contemplated. For example, a dual-fuel or bi-fuel GTE may be capable of being operated using a first type of fuel, a second type of fuel, and/or a combination of the first type of fuel and the second type of fuel. For example, the fuel may include gaseous fuels, such as, for example, compressed natural gas (CNG), natural gas, field gas, pipeline gas, methane, propane, butane, and/or liquid fuels, such as, for example, diesel fuel (e.g., #2 diesel), bio-diesel fuel, bio-fuel, alcohol, gasoline, gasohol, aviation fuel, and other fuels as will be understood by those skilled in the art. Gaseous fuels may be supplied by CNG bulk vessels, a gas compressor, a liquid natural gas vaporizer, line gas, and/or well-gas produced natural gas. Other types and associated fuel supply sources are contemplated. The one or more GTEs 16 may be operated to provide horsepower to drive the transmission 22 connected to one or more of the hydraulic fracturing pumps 20 to safely and successfully fracture a formation during a well stimulation project or fracturing operation.

In some embodiments, the fracturing fluid may include, for example, water, proppants, and/or other additives, such as thickening agents and/or gels, such as guar. For example, proppants may include grains of sand, ceramic beads or spheres, shells, and/or other particulates, and may be added to the fracturing fluid, along with gelling agents to create a slurry as will be understood by those skilled in the art. The slurry may be forced via the hydraulic fracturing pumps 16 into the formation at rates faster than can be accepted by the existing pores, fractures, faults, or other spaces within the formation. As a result, pressure in the formation may build rapidly to the point where the formation fails and begins to fracture. By continuing to pump the fracturing fluid into the formation, existing fractures in the formation may be caused to expand and extend in directions away from a well bore, thereby creating additional flow paths for hydrocarbons to flow to the well. The proppants may serve to prevent the expanded fractures from closing or may reduce the extent to which the expanded fractures contract when pumping of the fracturing fluid is ceased. Once the well is fractured, large quantities of the injected fracturing fluid may be allowed to flow out of the well, and the water and any proppants not remaining in the expanded fractures may be separated from hydrocarbons produced by the well to protect downstream equipment from damage and corrosion. In some instances, the production stream of hydrocarbons may be processed to neutralize corrosive agents in the production stream resulting from the fracturing process.

In the example shown in FIG. 1, the hydraulic fracturing system 10 may include one or more water tanks 24 for supplying water for fracturing fluid, one or more chemical additive units 26 for supplying gels or agents for adding to the fracturing fluid (e.g., guar, etc.), and one or more proppant tanks 28 (e.g., sand tanks) for supplying proppants for the fracturing fluid. The example hydraulic fracturing system 10 shown also includes a hydration unit 30 for mixing water from the water tanks 24 and gels and/or agents from the chemical additive units 26 to form a mixture, for example, gelled water. The example shown also includes a blender 32, which receives the mixture from the hydration unit 30 and proppants via conveyers 34 from the proppant tanks 28. The blender 32 may mix the mixture and the proppants into a slurry to serve as fracturing fluid for the hydraulic fracturing system 10. Once combined, the slurry may be discharged through low-pressure hoses, which convey the slurry into two or more low-pressure lines in a fracturing manifold 36. In the example shown, the low-pressure lines in the fracturing manifold 36 may feed the slurry to the hydraulic fracturing pumps 20 through low-pressure suction hoses as will be understood by those skilled in the art.

The hydraulic fracturing pumps 20, driven by the respective GTEs 16, discharge the slurry (e.g., the fracturing fluid including the water, agents, gels, and/or proppants) at high flow rates and/or high pressures through individual high-pressure discharge lines into two or more high-pressure flow lines, sometimes referred to as “missiles,” on the fracturing manifold 36. The flow from the high-pressure flow lines is combined at the fracturing manifold 36, and one or more of the high-pressure flow lines provide fluid flow to a manifold assembly 38, sometimes referred to as a “goat head.” The manifold assembly 38 delivers the slurry into a wellhead manifold 40. The wellhead manifold 40 may be configured to selectively divert the slurry to, for example, one or more wellheads 42 via operation of one or more valves. Once the fracturing process is ceased or completed, flow returning from the fractured formation discharges into a flowback manifold, and the returned flow may be collected in one or more flowback tanks as will be understood by those skilled in the art.

As schematically depicted in FIG. 1, FIG. 2, and FIG. 3A, one or more of the components of the fracturing system 10 may be configured to be portable, so that the hydraulic fracturing system 10 may be transported to a well site, quickly assembled, operated for a relatively short period of time, at least partially disassembled, and transported to another location of another well site for use. For example, the components may be connected to and/or supported on a chassis 44, for example, a trailer and/or a support incorporated into a truck, so that they may be easily transported between well sites. In some embodiments, the GTE 16, the hydraulic fracturing pump 20, and/or the transmission 22 may be connected to the chassis 44. For example, the chassis 44 may include a platform 46, and the transmission 22 may be connected to the platform 46, and the GTE 16 may be connected to the transmission 22. In some embodiments, the GTE 16 may be connected to the transmission 22 without also connecting the GTE 16 directly to the platform 46, which may result in fewer support structures being needed for supporting the GTE 16, hydraulic fracturing pump 20, and/or transmission 22 on the chassis 44.

As shown in FIG. 1, some embodiments of the hydraulic fracturing system 10 may include one or more fuel supplies 48 for supplying the GTEs 16 and any other fuel-powered components of the hydraulic fracturing system 10, such as auxiliary equipment, with fuel. The fuel supplies 48 may include gaseous fuels, such as compressed natural gas (CNG), natural gas, field gas, pipeline gas, methane, propane, butane, and/or liquid fuels, such as, for example, diesel fuel (e.g., #2 diesel), bio-diesel fuel, bio-fuel, alcohol, gasoline, gasohol, aviation fuel, and other fuels as will be understood by those skilled in the art. Gaseous fuels may be supplied by CNG bulk vessels, such as fuel tanks coupled to trucks, a gas compressor, a liquid natural gas vaporizer, line gas, and/or well-gas produced natural gas. The fuel may be supplied to the hydraulic fracturing units 12 by one of more fuel lines supplying the fuel to a fuel manifold and unit fuel lines between the fuel manifold and the hydraulic fracturing units 12. Other types and associated fuel supply sources and arrangements are contemplated as will be understood by those skilled in the art.

As shown in FIG. 1, some embodiments also may include one or more data centers 50 configured to facilitate receipt and transmission of data communications related to operation of one or more of the components of the hydraulic fracturing system 10. Such data communications may be received and/or transmitted via hard-wired communications cables and/or wireless communications, for example, according to known communications protocols. For example, the data centers 50 may contain at least some components of a hydraulic fracturing control assembly, such as a supervisory controller configured to receive signals from components of the hydraulic fracturing system 10 and/or communicate control signals to components of the hydraulic fracturing system 10, for example, to at least partially control operation of one or more components of the hydraulic fracturing system 10, such as, for example, the GTEs 16, the hydraulic fracturing pumps 20, and/or the transmissions 22 of the hydraulic fracturing units 12, the chemical additive units 26, the hydration units 30, the blender 32, the conveyers 34, the fracturing manifold 36, the manifold assembly 38, the wellhead manifold 40, and/or any associated valves, pumps, and/or other components of the hydraulic fracturing system 10.

As shown in FIGS. 3A and 3B, in some embodiments, the transmission 22 may include a transmission input shaft 52 connected to a prime mover output shaft 54 (e.g., a turbine output shaft), such that the transmission input shaft 52 rotates at the same rotational speed as the prime mover output shaft 54. The transmission 22 may also include a transmission output shaft 56 positioned to be driven by the transmission input shaft 52 at a different rotational speed than the transmission input shaft 52. In some embodiments, the transmission 22 may be a reduction gearbox, which results in the transmission output shaft 56 having a relatively slower rotational speed than the transmission input shaft 52. The transmission 22 may include a continuously variable transmission, an automatic transmission including one or more planetary gear trains, a transmission shiftable between different ratios of input-to-output, etc., or any other suitable of types of transmissions as will be understood by those skilled in the art.

As shown in FIGS. 3A and 3B, in some embodiments, the hydraulic fracturing pump 20 may be, for example, a reciprocating fluid pump, as explained herein. In some embodiments, the hydraulic fracturing pump 20 may include a pump drive shaft 58 connected to the transmission output shaft 56, such that the transmission output shaft 56 drives the pump drive shaft 58 at a desired rotational speed. For example, the transmission output shaft 56 may include an output shaft connection flange, and the pump drive shaft 58 may include a drive shaft connection flange, and the output shaft connection flange and the drive shaft connection flange may be coupled to one another, for example, directly connected to one another. In some embodiments, the transmission output shaft 56 and the pump drive shaft 58 may be connected to one another via any known coupling types as will be understood by those skilled in the art (e.g., such as a universal joint and/or a torsional coupling).

As shown in FIGS. 2 and 3A, in some embodiments, the chassis 44 may be or include a trailer 60 including the platform 46 for supporting components of the hydraulic fracturing unit 12, one or more pairs of wheels 62 facilitating movement of the trailer 60, a pair of retractable supports 64 to support the hydraulic fracturing unit 12 during use, and a tongue 66 including a coupler 68 for connecting the trailer 60 to a truck for transport of the hydraulic fracturing unit 12 between well sites to be incorporated into a hydraulic fracturing system 10 of a well site fracturing operation, as will be understood by those skilled in the art.

As shown in FIGS. 2, 3A, and 3B, some embodiments of the intake air treatment assembly 14 may include a turbine housing 70 configured to at least partially enclose the GTE 16 and the inlet assembly 18. The turbine housing 70 may be positioned to facilitate supply of intake air to the inlet assembly 18 of the GTE 16. The turbine housing 70 may be connected to and supported by the chassis 44 according to embodiments of the disclosure. In some embodiments, as shown in FIGS. 3A and 3B, the GTE 16 may be connected to the transmission 22 via the prime mover output shaft 54 and the transmission input shaft 52, both of which may be substantially contained within the turbine housing 70. The inlet assembly 18 may include an air intake duct 72 and a turbine exhaust duct 74 passing through walls of the turbine housing 70 and connected to the GTE 16. The GTE 16 may be connected to the hydraulic fracturing pump 20 via the transmission 22, with the transmission output shaft 56 connected to the pump drive shaft 58, for example, as explained herein.

As shown in FIGS. 1, 2, 3A, and 3B, some embodiments of the hydraulic fracturing pump 20 may have physical dimensions configured such that the hydraulic fracturing pump 20 does not exceed the space available on the platform 46, for example, while still providing a desired pressure output and/or flow output to assist with performing the fracturing operation as explained herein. For example, the hydraulic fracturing pump 20 may have a pump length dimension substantially parallel to a longitudinal axis of the platform 46 that facilitates placement and/or connection of the hydraulic fracturing pump 20 on the platform 46, for example, without causing the hydraulic fracturing unit 12 to exceed a length permitted for transportation on public highways, for example, in compliance with government regulations. In some embodiments, for example, as shown in FIG. 2, the hydraulic fracturing pump 20 may have a pump width dimension substantially perpendicular to a longitudinal axis of the platform 46 that facilitates placement and/or connection of the hydraulic fracturing pump 20 on the platform 46, for example, without causing the hydraulic fracturing unit 12 to exceed a width permitted for transportation on public highways, for example, in compliance with government regulations. For example, the hydraulic fracturing pump 14 may have a pump width perpendicular to the longitudinal axis of the platform 46, such that the pump width is less than or equal to the width of the platform, for example, as shown in FIG. 2. As shown in FIG. 2, in some embodiments, as viewed from the rear of the platform 46 and in a direction substantially parallel to the longitudinal axis of the platform 46, an end of the hydraulic fracturing pump 20 may take on the appearance of an inverted V and may include two, four, six, eight, or more plungers that reciprocate in two banks of plungers in planes defining an angle therebetween ranging, for example, from about 20 degrees to about 180 degrees (e.g., from about 30 degrees to about 120 degrees, about 90 degrees, about 70 degrees, about 60 degrees, or about 45 degrees). Hydraulic fracturing pumps having an in-line architecture and having two or more plungers (e.g., three, four, five, or more plungers) reciprocating in a common plane are contemplated

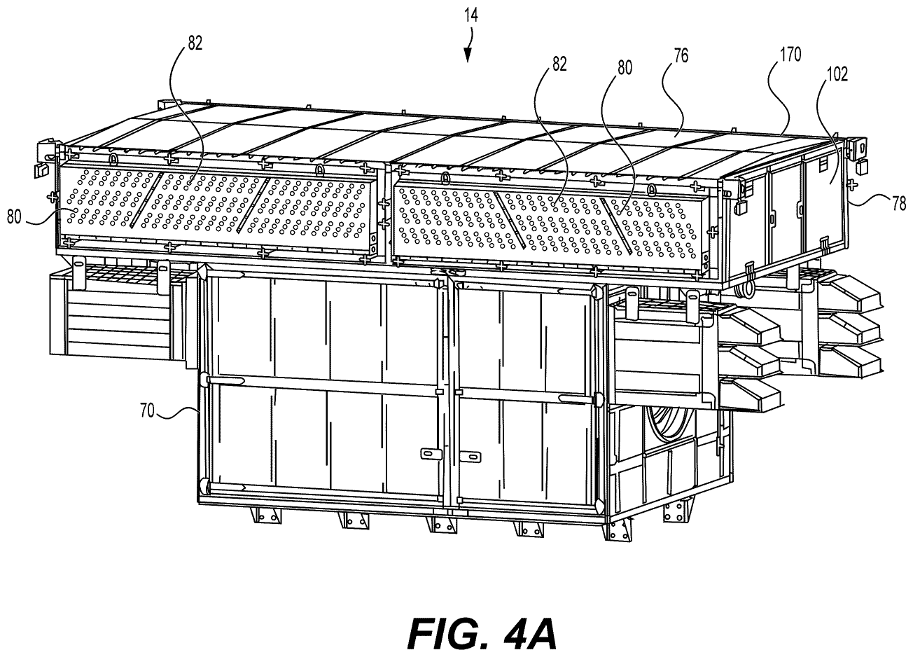

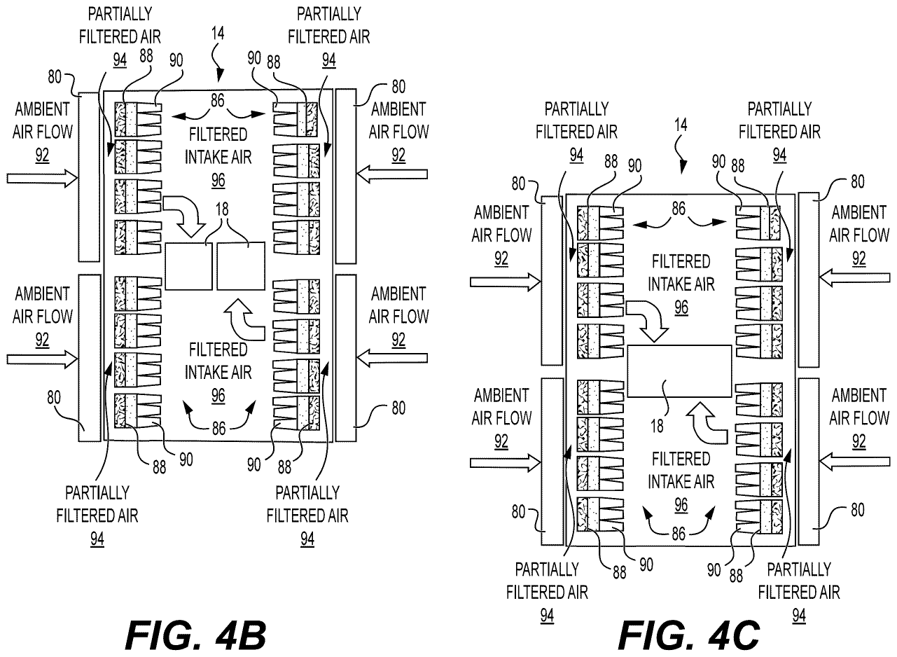

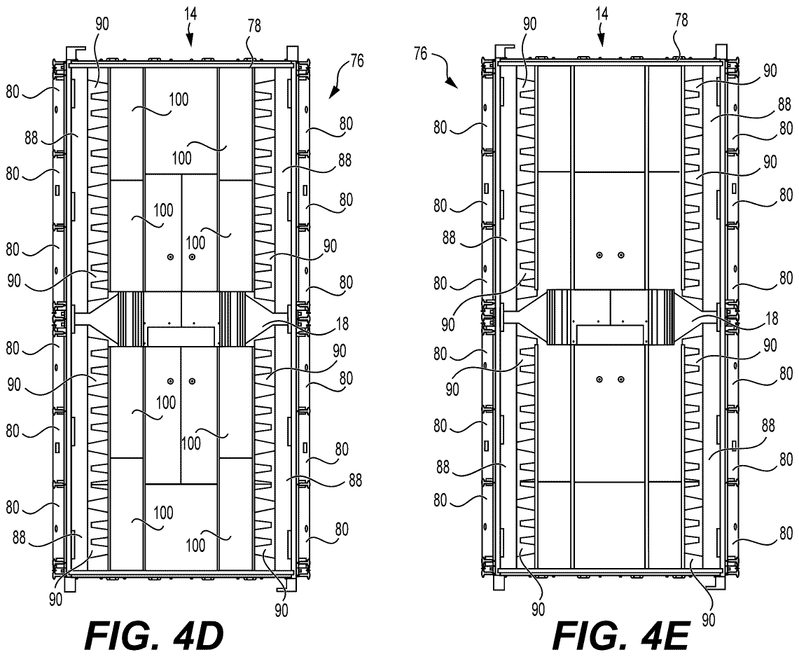

As shown in FIG. 2, FIG. 3A, FIG. 3B, FIG. 4B, FIG. 4C, FIG. 4D, and FIG. 4E, some embodiments of the intake air treatment assembly 14 may include a filtration assembly 76 connected to the turbine housing 70 and positioned to provide a flow path to supply at least partially filtered intake air to the inlet assembly 18 of the GTE 16. For example, FIGS. 4A-4E show schematic views of an example intake air treatment assembly 14, according to embodiments of the disclosure.

For example, the filtration assembly 76 may include a filtration housing 78 connected to the turbine housing 70, for example, as shown. In some embodiments, the filtration assembly 76 may include one or more pre-cleaners 80 positioned to receive ambient air drawn into the filtration assembly 76 via operation of the GTE 16. As shown, in some embodiments, the one or more pre-cleaners 80 may include one or more inertial separators 82 configured to separate a first portion of particles and/or liquid from the ambient air, thereby to provide at least partially filtered intake air for use by the GTE 16 during operation. For example, the ambient air, particularly in harsh environments common to oilfield operations, may include contaminates, such as particles and/or liquid, including, for example, sand, dust, dirt, water, ice, proppants, and/or fracturing fluid additives, such as thickening agents and/or gels, such as guar. For example, proppants may include grains of sand, ceramic beads or spheres, shells, and/or other particulates, along with gelling agents, and such materials may become suspended in the ambient air and drawn into the GTE 16 during operation, unless separated from the ambient air, for example, via the pre-cleaners 80 and/or other types of filtration. In some embodiments, the one or more pre-cleaners 80 may be configured to separate one or more of these contaminates from ambient air supplied to the GTE 16 during operation to prevent damage to components of the GTE 16 and/or to reduce maintenance and/or downtime associated with the GTE 16, for example, as discussed herein.

In some embodiments, the filtration housing 78 and one or more of the pre-cleaners 80 may at least partially define a filtration chamber 84, for example, as shown in FIGS. 4B-4E. The filtration assembly 76 may include one or more filters 86 positioned in the filtration chamber 84 and positioned in the flow path downstream of the one or more pre-cleaners 80 and configured to separate a second portion of the particles and/or liquid from the at least partially filtered intake air received from the one or more pre-cleaners 80, thereby to provide at least partially (e.g., further) filtered intake air to the inlet assembly 18 of the GTE 16. For example, the one or more filters 86 may serve to separate additional particles and/or liquid from the partially filtered ambient air received from the one or more pre-cleaners 80. In some embodiments, the pre-cleaners 80 may be configured to separate relatively larger particles and/or larger liquid droplets from the ambient air, and the filters 84 may be configured to separate relatively smaller particles and/or larger liquid droplets from the partially filtered ambient air received from the pre-cleaners 80, for example, as described herein. Use of the pre-cleaners 80, in some embodiments, may reduce the frequency with which the filters 86 need to be serviced or replaced due to obstruction or clogging by particles and/or liquid in the ambient air. In some embodiments, as shown in FIGS. 4B and 4C, the one or more filters 86 may include one or more pre-filters 88 and/or one or more final filters 90, and in some embodiments, additional filtration downstream of the pre-filters 88 and/or the final filters 90. In some embodiments, the one or more pre-filters 88 may include one or more medium-efficiency intermediate filters (e.g., one or more cartridge-type pre-filters and/or bag-type pre-filters), and the one or more final filters 90 may include one or more high-efficiency final filters.

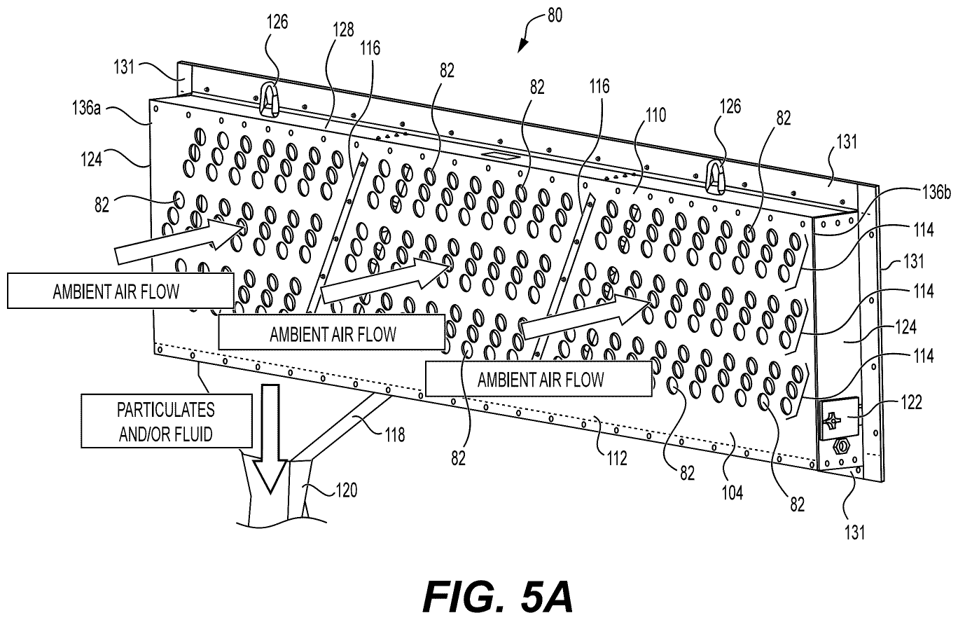

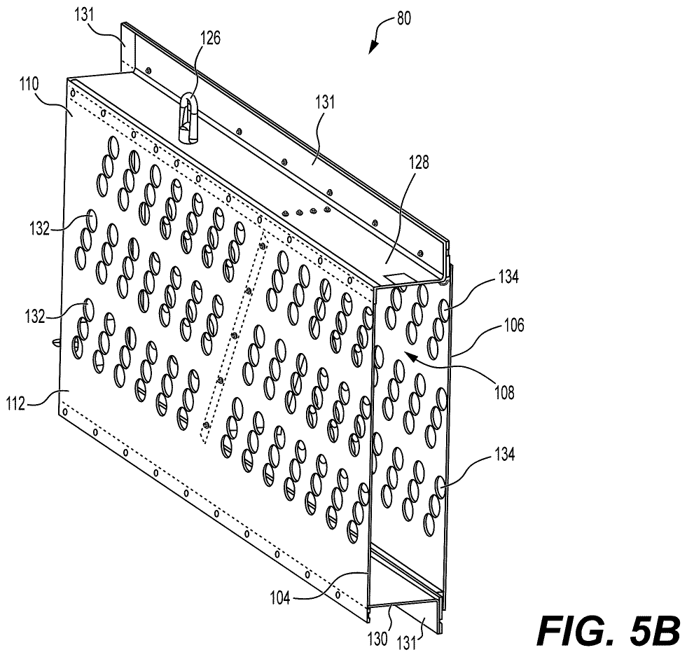

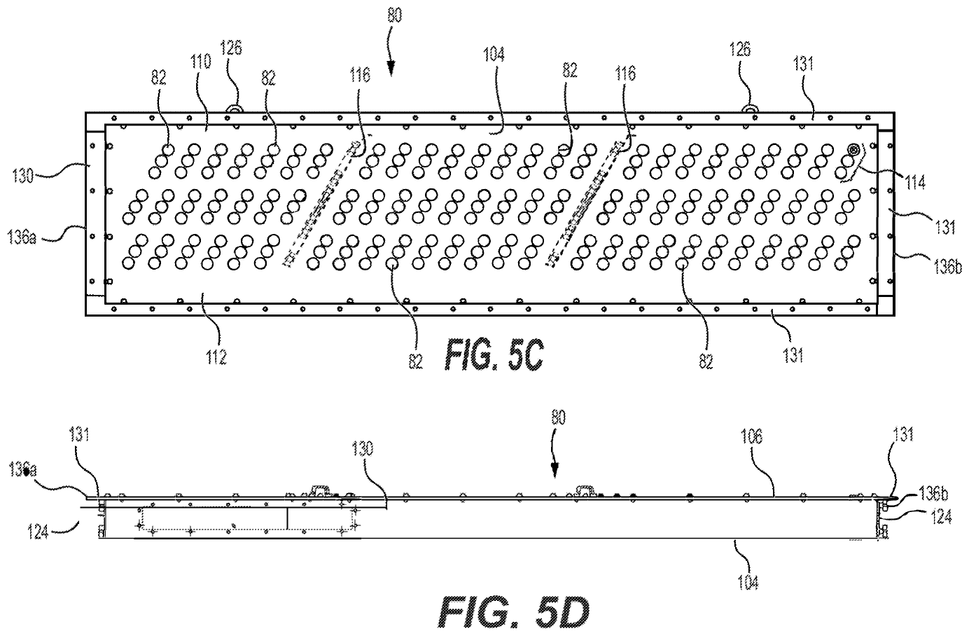

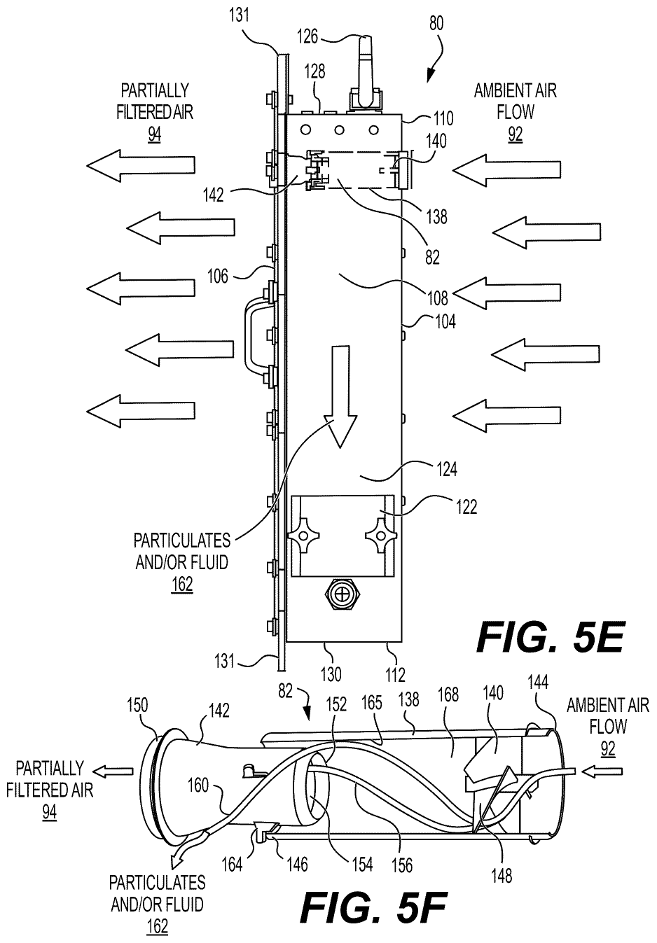

FIG. 4B is a schematic top view of an example intake air treatment assembly 14 showing an example flow path, according to embodiments of the disclosure. As shown in FIG. 4B, in some embodiments, during operation of the GTE 16, ambient air 92 is drawn into the filtration housing 78 via the one or more pre-cleaners 80. As described herein, the pre-cleaners 80 may include one or more inertial separators 82 (see, e.g., FIGS. 4A and 5A-5F) configured to separate a first portion of particles and/or liquid from the ambient air 92, thereby to provide at least partially filtered intake air 94. The at least partially filtered intake air 94 may be further drawn into and through the one or more filters 86, including, in at least some embodiments, the pre-filters 88 and/or the final filters 90 downstream relative to the pre-cleaners 80. The one or more filters 86 may be configured to separate a second portion of the particles and/or liquid from the at least partially filtered intake air 94, thereby to provide filtered intake air 96 (e.g., the at least partially filtered intake air, which may be further filtered relative to the at least partially filtered intake air 94 received from the pre-cleaners 80). As shown, in some embodiments, the filtered intake air 96 may be supplied to the inlet assembly 18 of the GTE 16, with or without additional filtration.

As shown in FIG. 4B, in some embodiments, the intake assembly 18 may be separated into two or more separate intake assemblies 18a and 18b configured to supply at least partially filtered intake air (e.g., intake air 96) to one or more GTEs 16. For example, in some embodiments, the two or more intake assemblies 18a and 18b may be configured to supply the at least partially filtered intake air 94 to a single GTE 16, for example, from opposite sides of the hydraulic fracturing unit 12 (e.g., from the driver side and the passenger side of the trailer 60). In some embodiments, the two or more intake assemblies 18a and 18b may be configured to supply the at least partially filtered intake air 94 to two or more GTEs 16 of a common hydraulic fracturing unit 12. FIG. 4C is a schematic top view of another example intake air treatment assembly 14 showing another example flow path, according to embodiments of the disclosure. In the example embodiment shown in FIG. 4C, the example intake assembly 18 may be a combined or single intake assembly 18 configured to supply at least partially filtered intake air (e.g., the at least partially filtered intake air 96) to one or more GTEs 16. For example, in some embodiments, the single intake assembly 18 may be configured to supply the at least partially filtered intake air 94 to a single GTE 16 of a hydraulic fracturing unit 12. In some embodiments, the single intake assembly 18 may be configured to supply the at least partially filtered intake air 94 to two or more GTEs 16 of a common hydraulic fracturing unit 12.

FIG. 4D is a schematic top view of an example intake air treatment assembly 14 including example sound attenuation baffles 100, according to embodiments of the disclosure, and FIG. 4E is a schematic top view of another example intake air treatment assembly 14 without sound attenuation baffles, according to embodiments of the disclosure. As shown in FIG. 4D, some embodiments of the intake air treatment assembly 14 may include one or more sound attenuation baffles received in the filtration chamber 84 and configured to reduce sound generated during operation of the GTE 16 caused by air drawn into the filtration chamber 84 during operation of the GTE 16. In the example shown, the sound attenuation baffles 100 are positioned downstream relative to the pre-cleaners 80 and the filters 86, but upstream relative to the inlet assembly 18, which may include an inlet plenum (and/or inlet manifold), for example, as shown in FIGS. 4D and 4E.

In some embodiments, the filtration housing 78 may include one or more access panels 102 positioned to facilitate access to the filtration chamber 84, as shown in FIG. 4A. For example, the access panels 102 may enable maintenance or replacement of the filters 86 and/or the sound attenuation baffles 100, for example, if the filtration chamber 84 houses sound attenuation baffles 100. Some embodiments may not include sound attenuation baffles, for example, as shown in FIG. 4E.

FIG. 5A, FIG. 5B, FIG. 5C, FIG. 5D, and FIG. 5E are schematic views of an example pre-cleaner 80, according to embodiments of the disclosure. FIG. 5A is a schematic perspective view of the example pre-cleaner 80 viewed from an exterior side. In some embodiments, one or more of the pre-cleaners 80 may include one or more inertial separators 82 configured to separate particles and/or liquid from ambient air 92 passing through the pre-cleaners 80, thereby to provide at least partially filtered intake air 94 (see, e.g., FIGS. 4B and 4C). As shown in FIGS. 5A and 5B, in some embodiments, the pre-cleaners 80 may include an exterior panel 104 facing outward from the filtration assembly 76, and an interior panel 106 opposite the exterior panel 104 and facing inward toward an interior of the filtration assembly 76, for example, toward the filtration chamber 84. The exterior panel 104 and the interior panel 106 may at least partially define a separator cavity 108 therebetween, for example, as shown in FIG. 5B.

As shown in FIGS. 5A, 5B, 5C, and 5E, the exterior panel 104 and/or the interior panel 106 may at least partially define an upper end 110 and a lower end 112, and a plurality of the inertial separators 82 may be arranged in groups 114 extending diagonally between the upper end 110 and the lower end 112 of the pre-cleaner 80. For example, as shown in FIGS. 5A-5C, the groups 114 of inertial separators 82 may include two or more inertial separators 82 (e.g., groups of three inertial separators 82 as shown), and/or the groups 114 may be spaced from one another lengthwise and/or height-wise across the pre-cleaners 80. For example, as shown, the pre-cleaners 80 may include multiple groups 114 spaced across the pre-cleaners 80 and from the upper end 110 toward the lower end 112 of the pre-cleaners 80. In some embodiments, the spacing may facilitate internal reinforcement of the pre-cleaners 80, for example, with internal bracing 116 to prevent the exterior panel 104 and/or the interior panel 106 from deflecting toward one another and/or collapsing during operation of the GTE 16. In some embodiments, the spacing and/or the diagonal arrangements of the groups 114 may allow particles and/or liquid separated from the ambient air 92 by the inertial separators 82 to fall or drop to a lower end of the separator cavity 108 to facilitate removal of the separated particles and/or liquid from the pre-cleaners 80. Other configurations of groups 114 of the inertial separators 82 are contemplated. In some embodiments, the inertial separators 82 may not be arranged in groups across the pre-cleaner 80.

As shown, some embodiments of the pre-cleaner 80 may include a pre-cleaner bypass 118 connected to the pre-cleaner 80 and positioned to receive ambient air expelled from the inertial separators 82 that does not exit the pre-cleaner 80 via the interior panel 106 and/or that includes the first portion of the particles and/or liquid separated from the ambient air 92. For example, some of the ambient air 92 entering the pre-cleaner 80, rather than exiting the pre-cleaner 80 via the inertial separators 82, may be expelled from the pre-cleaner 80 via the pre-cleaner bypass 118. In some embodiments, as particles and/or liquid separated from the ambient air 92 by the inertial separators 82 fall or drop within the separator cavity 108, the particles and/or liquid may pass through the pre-cleaner bypass 118 located at the lower end 112 of the pre-cleaner 80. In some embodiments, the pre-cleaner bypass 118 may be configured to be connected to a conduit 120 configured to draw-off the ambient air and/or the particles and/or liquid passing into the pre-cleaner bypass 118 from the intake air treatment assembly 14, for example, as shown in FIG. 5A.

As shown in FIGS. 5A and 5E, some embodiments of the pre-cleaner 80 may include one or more access plates 122 configured to provide access to the separator cavity 108, for example, to service the pre-cleaner 80 and/or remove particles and/or liquid from the separator cavity 108, for example, particles and/or liquid that do not drop into the pre-cleaner bypass 118. For example, the pre-cleaner 80 may include side panels 124 at opposite longitudinal ends of the pre-cleaner 80 and extending between the exterior panel 104 and the interior panel 106, and one or more access plates 122 may be located at lower ends of one or more of the side panels 124.

In some embodiments, the pre-cleaner 80 may include one or more lifting fixtures 126 configured to facilitate lifting and mounting of the pre-cleaner 80 to the filtration housing 78. The lifting fixtures 126 may include, for example, hooks, eyebolts, and/or other devices to facilitate lifting of the pre-cleaner 80 via a lifting mechanism, such as a forklift or crane. For example, the pre-cleaner 80 may include an upper panel 128 and a lower panel 130 at the upper end 110 and lower end 112, respectively, of the pre-cleaner 80 and extending between the exterior panel 104 and the interior panel 106, and one or more lifting fixtures 126 may be located at the upper panel 128. The side panels 124, the upper panel 128, and the lower panel 130 may at least partially define the separator cavity 108 of the pre-cleaner 80.

As shown in FIG. 5A, the pre-cleaner 80 may include one or more flanges 131 extending outward from a perimeter of the pre-cleaner 80. The one or more flanges 131 may facilitate connection of the pre-cleaner 80 to the filtration assembly 76 via, for example, one or more fasteners, adhesives, and/or welding.

As shown in FIG. 5B, for example, in some embodiments, the exterior panel 104 may at least partially define one or more exterior holes 132, and the interior panel 106 may at least partially define one or more interior holes 134. The one or more exterior holes 132 and the one or more interior holes 134 may provide mounting points for the one or more inertial separators 82, for example, as described with respect to FIG. 5E and FIG. 5F.

For example, as schematically shown in FIG. 5E, an example inertial separator 82 extends between the exterior panel 104 and the interior panel 106 with opposite ends of the inertial separator 82 being connected to the exterior panel 104 and the interior panel 106 at respective exterior holes 132 and interior holes 134, with exterior holes 132 providing ambient air flow into the pre-cleaner 80 via the inertial separator 82. The interior holes 134 provide partially filtered air flow from the inertial separator 82 into the filtration chamber 84.

As shown in FIG. 5E and FIG. 5F, in some embodiments, the one or more pre-cleaners 80 may include one or more (e.g., a plurality of) inertial separators 82 to separate a first portion of particles and/or liquid from the ambient air 92, thereby to provide the at least partially filtered intake air 94 for operation of the GTE 16. For example, as shown, the one or more inertial separators 82 may include an air flow tube 138, a diverter 140, and/or a separator tube 142. As shown in FIG. 5F, the air flow tube 138 may have a proximal end 144 connected to the exterior panel 104, may extend toward the interior panel 106, and may terminate at a distal end 146. In some embodiments, the diverter 140 may be connected to the air flow tube 138 and may be positioned to cause the ambient air 92 entering the air flow tube 138 to swirl as the ambient air 92 flows from the proximal end 144 of the air flow tube 138 to the distal end 146 of the air flow tube 138, for example, as schematically depicted in FIG. 5F. For example, the diverter 140 may include one or more stator blades 148 presenting one or more curved surfaces to cause the ambient air 92 entering the air flow tube 138 to swirl as the ambient air 92 passes the one or more stator blades 148 and flows from the proximal end 144 of the air flow tube 138 to the distal end 146 of the air flow tube 138.

As shown in FIGS. 5E and 5F, in some embodiments, the separator tube 142 may be connected to the interior panel 106 and may extend from the interior panel 106 toward the distal end 146 of the air flow tube 138. The separator tube 142 may have a proximal end 150 connected to the interior panel 106 and may terminate at a distal end 152. As shown, in some embodiments, the air flow tube 138 may define an interior cross-sectional area, and the separator tube 142 may have an exterior cross-sectional area smaller than the interior cross-sectional area of the air flow tube 138, for example, and the distal end 152 of the separator tube 142 may be received in the distal end 146 of the air flow tube 138, such that the distal end 152 of the separator tube 142 terminates between the distal end 146 and the proximal end 144 of the air flow tube 138, for example, as shown in FIG. 5F.

In some embodiments, the separator tube 142 may be connected to the interior panel 106, such that an interior passage 154 of the separator tube 142 provides a first separator flow path 156 for the at least partially filtered intake air 94 to exit the inertial separator 82 through the interior passage 154 of the separator tube 142 and the interior hole 134 of the interior panel 106. For example, as shown in FIG. 5F, the separator tube 142 may be positioned relative to the distal end 146 of the air flow tube 138 to provide the first separator flow path 156 for the at least partially filtered intake air 94 to exit the pre-cleaner 80 through the interior passage 154 of the separator tube 142. In some embodiments, the distal end 146 of the air flow tube 138 may be connected to the separator tube 142 (e.g., at an exterior surface 158, as shown) and may at least partially define a second separator flow path 160 for the first portion of particles and/or liquid 162 to be separated from the ambient air 92 entering the inertial separator 82. For example, one or more struts 164 may connect the exterior surface 158 of the distal end 152 of the separator tube 142 to the distal end 146 of the air flow tube 138, for example, as shown in FIG. 5F.

In some embodiments, the second separator flow path 160 may be configured and/or positioned to deposit the first portion of the particles and/or liquid 162 into the separator cavity 108, for example, as shown in FIG. 5E. For example, the distal end 146 of the air flow tube 138 may terminate between the exterior panel 104 and the interior panel 106, thereby at least partially defining the second separator flow path 160 for the first portion of the particles and/or liquid 162 to be separated from the ambient air 92 entering the inertial separator 82, with the second separator flow path 160 passing between the exterior surface 158 of the separator tube 142 and an interior surface 166 of the air flow tube 138. As shown in FIG. 5F, in some embodiments, an interior passage 168 of the air flow tube 138, the interior passage 154 of the separator tube 142, and/or the exterior surface 158 of the separator tube 142 may have a substantially circular cross-sectional shape. Other cross-sectional shapes are contemplated.

Applicant has recognized that for some embodiments, for ambient air that flows through the pre-cleaners 80 via the inertial separators 82, as the velocity of the ambient air increases, the resistance or pressure against the flow of the ambient air also increases, which reduces the efficiency of operation and/or the power output of the GTE 16. Thus, reducing the velocity of the ambient air flowing through the pre-cleaner 80 via the inertial separators 82 may result in more efficient operation and/or a higher power output of the GTE 16. Applicant has also recognized that reducing the velocity of the ambient air flowing through the pre-cleaner 80 and the inertial separators 82 also reduces the effectiveness of the removal of particles and/or liquid from the ambient air passing through the inertial separators 82.

Some embodiments according to the present disclosure address the high pressure associated with high ambient air velocities and/or the reduced effectiveness of the particle and/or liquid separation by (1) reducing the cross-sectional area of the inertial separators 82 (e.g., by reducing the diameter of the inertial separators 82, for example, when the interior passage 168 of the air flow tube 138, the interior passage 154 of the separator tube 142, and/or the exterior surface 158 of the separator tube 142 have a substantially circular cross-sectional shape), and/or (2) providing relatively more inertial separators 82 per unit area of the pre-cleaner 80. By reducing the cross-sectional area of the inertial separators 82, the angular acceleration of particles and/or liquid in the ambient air 92 is increased for a given air flow velocity, which, in turn, causes the particles and/or liquid to be forced outward toward the interior surface 166 of the air flow tube 138 by the diverter 140 as the particles and/or liquid travel in a substantially helical path down the length of the air flow tube 138 between the proximal end 144 of the air flow tube 138 to the distal end 146 of the air flow tube 138 (see, e.g., FIG. 5F). Because the particles and/or liquid are forced outward by the relatively higher angular acceleration due to centrifugal force due to the smaller diameter, the particles and/or liquid travel radially outward relative to the distal end 152 of the separator tube 142 and follow the second separator flow path 160 into the separator cavity 108 of the pre-cleaner 80. The ambient air 92, separated from the particles and/or liquid that follows the second separator flow path 106, continues in through the interior passage 154 of the separator tube 142, following the first separator flow path 156. By reducing the cross-sectional area of the inertial separators 82, a relatively greater percentage of the particles and/or liquid in the ambient air 92 may be separated from the ambient air 92 by the inertial separators 82 for the ambient air 92 travelling at a given velocity. In some embodiments, this may facilitate reducing the velocity of the ambient air 92 flowing through the pre-cleaners 80 and thus reducing the pressure drop of the ambient air 92 passing through the pre-cleaners 80 to enhance operation of the GTE 16, while maintaining, or even increasing, the effectiveness of the separation of particles and/or liquid from the ambient air 92.

In addition, by reducing the cross-sectional area of the inertial separators 82, relatively smaller particles (e.g., fine silica dust) and/or liquid droplets in the ambient air 92 may be more effectively separated from the ambient air 92 by the inertial separators 82 for the ambient air 92 travelling at a given velocity. According to some embodiments, this may be desirable in environments in which hydraulic fracturing operations are being performed due to the smaller dust particles and/or liquid droplets, sometimes including gels, that are often present in the ambient air 92 in such environments. According to some embodiments, by increasing the number of inertial separators 82 for given surface area of a pre-cleaner 80, the volume of ambient air 92 flowing through the pre-cleaner 80 during operation of the GTE 16 may be substantially maintained, even though the cross-sectional area of the inertial separators 82 may be relatively reduced.

In some embodiments, the cross-sectional area of the inertial separators 82 may be substantially circular, and the inertial separators 82 (e.g., measured at the air flow tube 138) may have a diameter ranging from about 0.5 inches to about 6 inches, for example, from about 0.5 inches to about 5.5 inches, from about 0.5 inches to about 5.0 inches, from about 0.5 inches to about 4.5 inches, from about 0.5 inches to about 4.0 inches, from about 0.5 inches to about 3.5 inches, from about 0.5 inches to about 3.0 inches, from about 0.5 inches to about 2.5 inches, from about 0.5 inches to about 2.0 inches, or from about 1.0 inches to about 2.0 inches (e.g., about 1.5 inches). In some embodiments, the size of the diameter may be critical for balancing the effectiveness of the inertial separators 82 with the velocity of the flow of the ambient air 92 as it passes through the inertial separators 82, which results in effective separation of the particles and/or liquid from the ambient air 92 and reducing the pressure drop of the ambient air 92 as it flows through the inertial separators 82. For example, the cross-sectional area of the inertial separators 82 may be based, at least in part, on one or more parameters, such as, for example, the desired volume flow rate of the at least partially filtered intake air 94 through the pre-cleaners 80, the available space for the pre-cleaners 80, the maximum desired pressure drop through the pre-cleaners 80, and/or the air flow velocity through the pre-cleaners 80 desired to generate sufficient centrifugal force to achieve desired particle separation efficiencies (e.g., for particle size ranges and/or particle types desired to be separated by the pre-cleaners 80). Other parameters are contemplated.

In some embodiments, the distance between the exterior panel 104 and the interior panel 106 of the pre-cleaners 80 may range from about 1.0 inch to about 10.0 inches, for example, from about 1.5 inches to about 9.5 inches, from about 2.0 inches to about 9.0 inches, from about 2.5 inches to about 8.5 inches, from about 3.0 inches to about 8.0 inches, from about 3.5 inches to about 7.5 inches, from about 4.0 inches to about 7.0 inches, from about 4.5 inches to about 6.5 inches, or from about 5.0 inches to about 6.0 inches (e.g., about 5.5 inches). In some embodiments, the distance between the exterior panel 104 and the interior panel 106, and thus, length of the inertial separators 82 may be critical for balancing the effectiveness of the inertial separators 82 with the velocity of the flow of the ambient air 92 as it passes through the inertial separators 82, which results in effective separation of the particles and/or liquid from the ambient air 92 and reducing the pressure drop of the ambient air 92 as it flows through the inertial separators 82.

In some embodiments, the ratio of the distance between the exterior panel 104 and the interior panel 106 of the pre-cleaners 80 to the diameter of the inertial separators 82 (e.g., measured at the air flow tube 138), for example, when the air flow tube 82 has a substantially circular cross-section) may range from about 1:1 to about 10:1, for example, from about 1:1 to about 9:1, from about 1:1 to about 8:1, from about 1:1 to about 7:1, from about 1:1 to about 6:1, from about 1:1 to about 5:1, from about 1:1 to about 4:1, from about 1.5:1 to about 4:1, from about 2:1 to about 4:1, from about 2.5:1 to about 4:1, or from about 3:1 to about 4:1 (e.g., about 3.5:1). In some embodiments, this ratio may be critical for balancing the effectiveness of the inertial separators 82 with the velocity of the flow of the ambient air 92 as it passes through the inertial separators 82, which results in effective separation of the particles and/or liquid from the ambient air 92 and reducing the pressure drop of the ambient air 92 as it flows through the inertial separators 82.

In some embodiments, the pre-cleaners 80 may be configured to separate particles and/or liquid present in the ambient air 92, where the particles and/or liquid include one or more of mud, rain, ice, snow, leaves, sawdust, chaff, sand, dust (e.g., silica dust), proppant materials, gels (e.g., guar), and/or other possible contaminates that may be present in the ambient air surrounding, for example, a hydraulic fracturing operation. In some embodiments, the pre-cleaners 80 may be configured to separate particles and/or liquid present in the ambient air 92 having a median particle size and/or a median droplet size ranging from about 1.0 micrometer (micron) to about 15 microns, for example, from about 1.5 microns to about 14 microns, from about 2.0 microns to about 13 microns, from about 2.5 microns to about 12 microns, from about 2.5 microns to about 11 microns, from about 2.5 microns to about 10 microns, from about 2.5 microns to about 9 microns, from about 2.5 microns to about 8 microns, from about 2.5 microns to about 7 microns, from about 2.5 microns to about 6 microns, from about 2.5 microns to about 5 microns, or from about 2.5 microns to about 4 microns (e.g., about 3 microns). In some embodiments, the pre-cleaners 80 may be configured to separate particles and/or liquid present in the ambient air 92 having a median particle size and/or a median droplet size of about 5.0 microns or less, for example, of about 4.5 microns or less, of about 4.0 microns or less, of about 3.5 microns or less, of about 3.0 microns or less, of about 2.5 microns or less, of about 2.0 microns or less, of about 1.5 microns or less, or of about 1.0 micron or less. In some embodiments, the particle size may be critical for sizing the cross-section of the inertial separators 82 (e.g., selecting the diameter of the inertial separators 82 (e.g., measured at the air flow tube 138)) and/or the distance between the exterior panel 104 and the interior panel 106 of the pre-cleaners 80, for example, to balance the effectiveness of the inertial separators 82 with the velocity of the flow of the ambient air 92 as it passes through the inertial separators 82, which may result in effective separation of the particles and/or liquid from the ambient air 92 and reducing the pressure drop of the ambient air 92 as it flows through the inertial separators 82.

In some embodiments, the pre-cleaners 80 may be configured to separate a percentage of particles and/or liquid present in the ambient air 92 ranging from about 87% to about 97% by weight, for example, from about 88% to about 96% by weight, from about 89% to about 96% by weight, or from about 90% to about 95% by weight, for example, for coarse particles and/or liquid present in the ambient air 92 having a median particle size and/or a median droplet size ranging from about 2.5 microns to about 10 microns. In some embodiments, the pre-cleaners 80 may be configured to separate a percentage of particles and/or liquid present in the ambient air 92 ranging from about 70% to about 90% by weight, for example, from about 71% to about 89% by weight, from about 72% to about 88% by weight, from about 73% to about 87% by weight, from about 74% to about 86% by weight, from about 75% to about 85% by weight, for example, for fine particles and/or liquid present in the ambient air 92 having a median particle size and/or a median droplet size of about 2.5 microns or less.

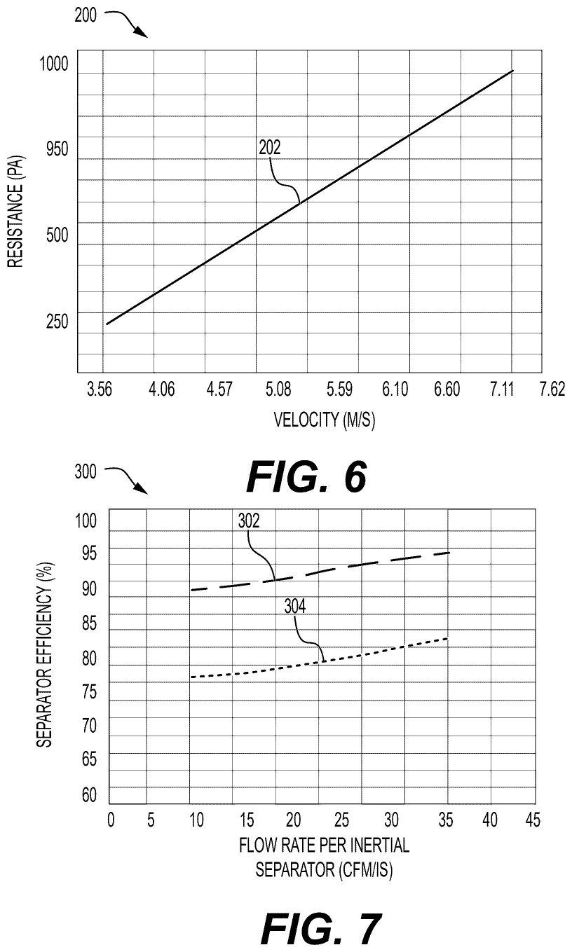

FIG. 6 is a graph 200 showing backpressure or pressure drop as a function of air velocity through an example inertial separator 82, according to embodiments of the disclosure. As shown by the example relationship 202 shown in FIG. 6, as the velocity of the ambient air flowing through the example inertial separator 82 increases, the resistance to flow through the inertial separator 82 also increases (e.g., the pressure drop through the example inertial separator 82 increases). Thus, as the velocity of the ambient air flowing through the example inertial separator 82 increases, the efficiency of operation of the GTE 16 may decrease and/or the power output of the GTE 16 may decrease, thereby potentially hindering operation of the GTE 16 and the hydraulic fracturing 3operation.

FIG. 7 is a graph 300 showing inertial separator efficiency as a function of flow rate through an example inertial separator 82 for example coarse particles 302 and example fine particles 304, according to embodiments of the disclosure. As shown by the example relationships 302 and 304 shown in FIG. 7, as the flow rate of the ambient air flowing through the example inertial separator 82 increases, the efficiency of the separation of particles from the ambient air by the example inertial separator 82 also increases. In addition, comparing the relationships 302 and 304 for course and fine particles shows that as the size of the particles present in the ambient air increases, the efficiency of the separation of the particles from the ambient air also increases for a given flow rate of the ambient air through the example inertial separator. Thus, although increasing the flow rate of the ambient air flowing through the example inertial separator 82 results in increasing the efficiency of the separation of particles, as shown in FIG. 6, this also increases the resistance to air flow through the example inertial separator, which, in turn, may adversely the effect of operation of the GTE 16, reducing the efficiency and/or power output of the GTE 16. As noted herein, some embodiments of the assemblies and/or processes according to embodiments described herein, may mitigate and/or overcome these potential drawbacks, as well as possibly others.

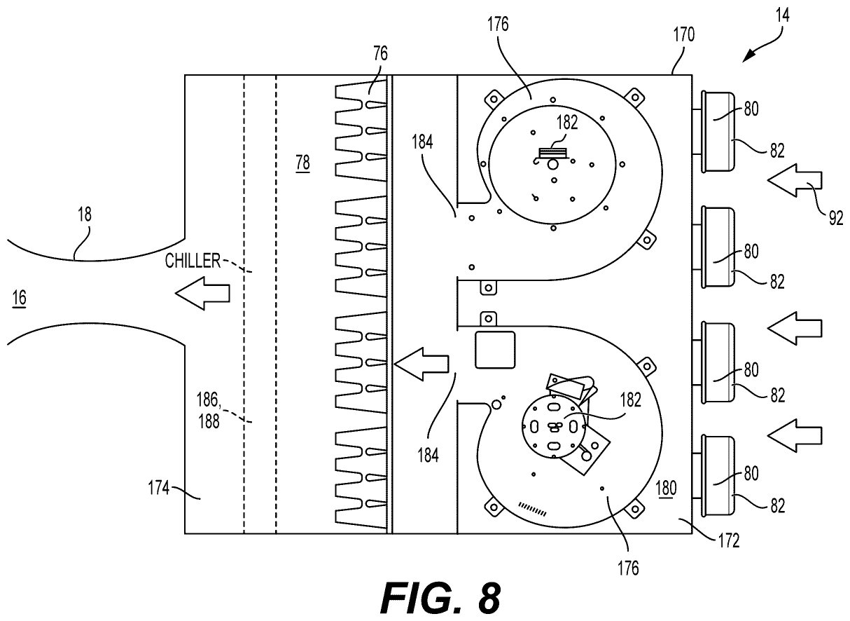

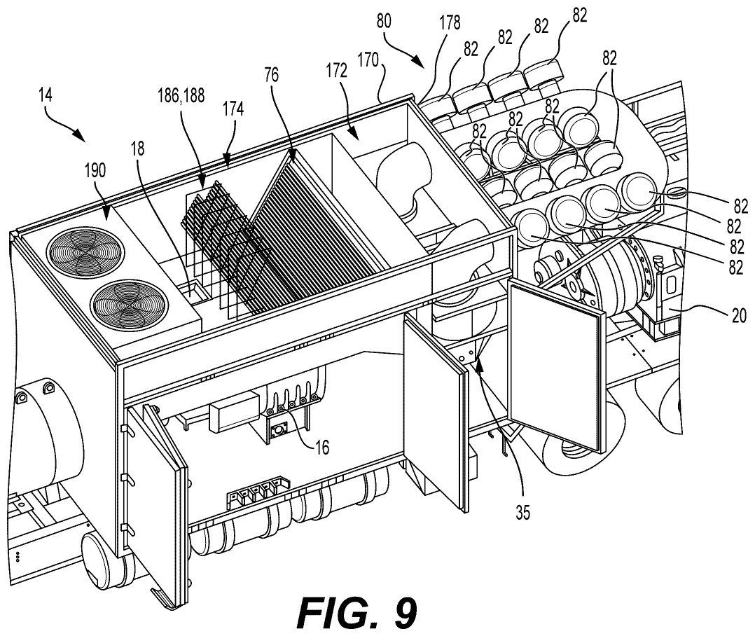

Referring to FIGS. 8 and 9, another example intake air treatment assembly 14 is described for operation with an example GTE 16. In some embodiments, the GTE 16 may generally include, in serial flow arrangement, an inlet assembly 18 including an inlet for receiving and channeling ambient air 92 to a compressor of the GTE 16, which receives and compresses the ambient air 92, a combusting assembly that mixes fuel and the compressed ambient air 92, ignites the mixture, and allows for the gaseous by-product to flow to a turbine section, which transfers energy from the gaseous by-product to an output power. Other components of the GTE 16 may be used therein as will be understood by those skilled in the art.

In some embodiments, the intake air treatment assembly 14 may be incorporated into a hydraulic fracturing unit, for example, as described herein. For example, a hydraulic fracturing unit 12 may include a trailer 60 and a hydraulic fracturing pump 20 to pump fracturing fluid into a wellhead 42, with the hydraulic fracturing pump 20 connected to the trailer 60, for example, as described herein. The hydraulic fracturing unit 12 also may include the GTE 16 to drive the hydraulic fracturing pump 20, for example, via a transmission 22 (e.g., a reduction gearbox), and the intake air treatment assembly 14, in some embodiments, may be used to increase the efficiency of operation of the GTE 16.

A hydraulic fracturing operation may be performed generally at any geographic location and during any season of the year, often in harsh environmental conditions. As a result, hydraulic fracturing may occur under a wide variety of ambient temperatures and pressures, depending on the location and time of year. In addition, the load on hydraulic fracturing pumps and thus the GTEs may change or fluctuate greatly, for example, depending on the build-up and release of pressure in the formation being fractured during the fracturing operation. In some embodiments, the intake air treatment assembly 14 may be configured to increase the efficiency of operation of a GTE, for example, during operation in a wide variety of ambient conditions and/or under fluctuating loads. Performance losses may be expected at increased temperatures, increased altitude, and/or increased humidity when using a dual-fuel turbine system for a mobile hydraulic fracturing unit configured to drive a reciprocating hydraulic fracturing pump via a gearbox, or to drive a generator as part of a gen-set. These environmental conditions may lead to the air being less dense, which may adversely affect turbine system performance as the mass air flow through the air intake and one or more axial compression stages of the GTE are directly proportional to the power output of the GTE.

In some embodiments, as explained herein, the intake air treatment assembly 14 may include an air treatment housing 170, one or more pressure control assemblies 172, and one or more temperature control assemblies 174. In some embodiments, the filtration assembly 76 may be positioned between the one or more pressure control assemblies 170 and the inlet assembly 18 of the GTE 16. In some embodiments, the one or more pressure control assemblies 172 and/or one or more temperature control assemblies 174 may be configured to condition ambient air supplied to the GTE 16, for example, to cause a desired increase in the mass flow of air through the one or more axial compression stages of the GTE 16, thereby at least partially mitigating or overcoming any performance losses of the GTE 16 of a hydraulic fracturing unit 12 due to increased temperature, increased altitude, and/or increased humidity, while being able to respond to fluctuating loads.

As discussed herein, performance losses may be expected at increased temperature, increased altitude, and/or increased humidity, for example, when using a dual-fuel turbine system in a mobile application that is configured to drive a reciprocating hydraulic fracturing pump or drive a generator as part of a gen-set. These environmental conditions may lead to the air being less dense. The relative density of air may be an important factor for operation of a GTE as the mass air flow through the one or more axial compression stages may be directly proportional to the GTE's power output. The intake air treatment assembly 14, in some embodiments, may facilitate selective conditioning of intake air, which may cause a desired increase in air density of air entering the intake assembly of the GTE. For example, as described in more detail herein, in some embodiments, the intake air treatment assembly 14 may filter ambient air entering the intake air treatment assembly 14, may boost the pressure of ambient air entering the intake air treatment assembly 14, and/or may lower the temperature of the ambient air entering the intake air treatment assembly 14, for example, to increase the operating efficiency of the GTE.

For example, as schematically shown in FIG. 8, the example air treatment housing 170 may be configured to channel ambient air 92 towards the inlet assembly 18 of the GTE 16 and/or may be positioned upstream of the inlet assembly 18 of the GTE 16, which supplies a treated (e.g., filtered, pressure controlled, and/or temperature controlled (e.g., cooled)) flow of the ambient air to a compressor of the GTE 16. The air treatment housing 170 may include a filtration housing 78, a pressure control assembly 172, and/or a temperature control assembly 174 configured to facilitate structural integration into the inlet assembly 18 of the GTE 16. The integration of the inlet assembly 18 of the GTE 16 and the air treatment housing 170 may facilitate a more controlled flow of the ambient air flowing through pressure control assembly 172, the temperature control assembly 174, and/or the filtration assembly 76 and thereafter to the inlet assembly 18 of the GTE 16. The air treatment housing 170 may be connected to the inlet assembly 18 of the GTE 16 via, for example, a plenum and/or one or more connectors, such as, for example, one or more fasteners (e.g., screws, bolts, clamps, and/or rivets), adhesives, and/or welding. The air treatment housing 170 may be formed of, or may include, any one or more materials capable of supporting the air treatment housing 170. Such materials may include, for example, metal and/or other structural materials.

The pressure control assembly 172 may include one or more pre-cleaners 80 and one or more blower fans 176 configured to pressurize air entering the intake air treatment assembly 14. In some embodiments, the pressure control assembly 172 may be positioned at a proximal end 178 of the air treatment housing 170. The one or more pre-cleaners 80 may be in fluid communication with a first pressure control chamber 180 of the pressure control assembly 172, and the one or more blower fans 176 may be mounted in the first pressure control chamber 180 to pressurize air entering the first pressure control chamber 180 via the one or more pre-cleaners 80. In some embodiments, it is contemplated that the one or more pre-cleaners 80 separate or knock down debris, such as particles and/or liquid, present in the ambient air 92 entering the intake air treatment assembly 14, including mud, rain, ice, snow, leaves, sawdust, chaff, sand, dust (e.g., silica dust), proppant materials, gels (e.g., guar), and/or other possible contaminates. As shown in FIGS. 8 and 9, the pre-cleaners 80 may be, or include, inertial separators configured to continuously or intermittently eject particles and/or liquid before reaching a filtration assembly 76 that may be mounted internally within the air treatment housing 170, for example, without the need for further cleaning or shutting-down the associated hydraulic fracturing unit 12, for example, to replace one or more of the pre-cleaners 80.

In some embodiments, to at least partially compensate for any pressure drop through the one or more pre-cleaners 80 and/or to boost pressure and/or the flow rate of the air supplied to the GTE 16, the one or more blower fans 176, which may be operated by one or more motors, such as one or more electric motors, hydraulic motors, and/or pneumatic motors, may be provided and positioned to raise the overall air flow rate up to a desired air feed rate, such as, for example, about 28,000 cubic feet per minute (CFM), to increase an inlet pressure at the inlet of the GTE 16 with a resultant increase in efficiency of operation of the GTE 16. In some embodiments, for example, as schematically shown in FIG. 8, at least one of the one or more blower fans 176 may be connected to a motor 182 and may be positioned in the first pressure control chamber 180 of the pressure control assembly 172 to boost the pressure of intake air to a desired level after any pressure drop created as the ambient air 92 passes through the one or more pre-cleaners 80 and into the filtration assembly 76 downstream of the pressure control assembly 172. The one or more blower fans 176 may include a squirrel-cage blower fan and/or any other suitable types of blower fans, such as other conventional electrically, hydraulically, or pneumatically powered blower fans, such as vane axial fans. In some embodiments, the intake air treatment assembly 14 may be integrated with a bypass configured to circumvent the pressure control assembly 172, for example, to mitigate or reduce any pressure drop created when, for example, the pressure control assembly 172 is not operating.

In some embodiments, the one or more blower fans 176 may pressurize the air exiting the pressure control assembly 172 to a degree sufficient to at least partially overcome any pressure drop associated with air passing through the one or more pre-cleaners 80 positioned upstream and/or associated with the air passing through the pressure control assembly 172 positioned downstream relative to the pressure control assembly 172, and, if used, any downstream filtration assembly 76 positioned upstream of the pressure control assembly 172, as well as any other losses the system may encounter, such as rarefication of the inlet air to the one or more blower fans 176. For example, a downstream filter assembly 76 may include a pre-filter 88 and/or a final filter 90, such as a high-efficiency filter, a conventional vane inlet with a low cartridge-type pre-filter, and/or bag-type pre-filter that would be suitable for filtration, periodic cleaning, and/or replacement.

It is contemplated that the one or more blower fans 176 may be relatively oversized to allow for further pressurization of the air at the downstream inlet of the GTE 16. Such relative oversizing may allow for suitable compensation for the loss of atmospheric pressure and air density, for example, associated with higher geographic elevations. The change in pressure due to a change in elevation may be calculated via the following equation:

$$P = {{P}_{b} [ \frac{{T}_{b}}{{T}_{b} + {L}_{b} ( H - {H}_{b} )} ]}^{\frac{{g}_{0} M}{{R}^{*} {L}_{b}}}$$

where:
P=local atmospheric pressure;
Pb=static pressure at sea level;
Tb=temperature at sea level;
Lb=temperature lapse rate;
Hb=elevation at sea level;
H=local elevation;
R*=universal gas constant;
g₀=gravity; and
M=molar mass of air.

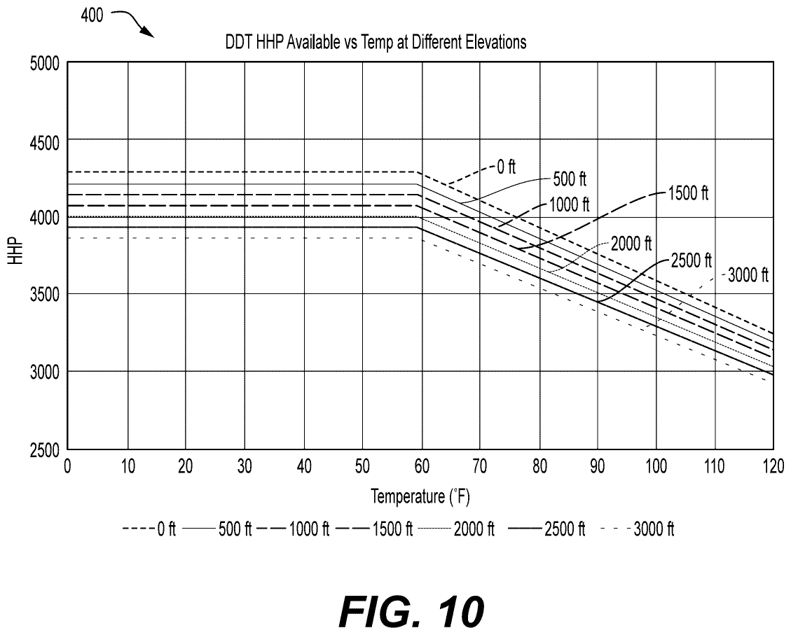

From the calculated pressure, a new or corrected density of the air at the constant atmospheric pressure may be calculated. FIG. 10 is a graph 400 showing the change in pressure as a function of increased elevation. It also shows the calculated density in reference to temperature change and elevation change.

$$ρ = \frac{p}{{R}_{sp} T}$$

where:
P=absolute pressure;
ρ=density;
T=absolute temperature; and
R_{SP}=specific gas constant.

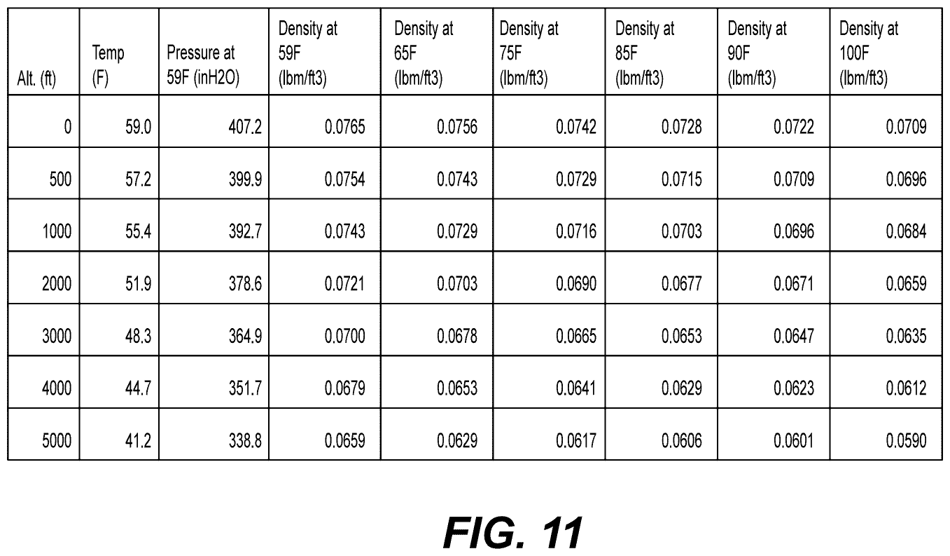

Referring now to FIG. 11, the conventional factor for performance loss of the GTE 16 with increased temperature is a 0.4% to about 0.5% reduction in performance for every one degree Fahrenheit (F) increase over 59 degrees F. For example, as shown in the graph 400, at 500 feet elevation, reducing the air temperature from about 100 degrees F. to about 90 degrees F., results in an output power increase from an example GTE of about 140 horsepower, or about 4%. This example increase in output power results from the temperature decreasing while maintaining a constant air pressure. The ideal gas law equation may be used to calculate the density of the air as a function of the change in temperature.

FIG. 11 illustrates, in tabular form, air properties at different elevations and temperatures. As shown in FIG. 11, for example, at an altitude of 500 feet, a decrease in air temperature from about 100 degrees F. to about 90 degrees F. will result in a density increase of 0.0013 lbm/ft³, or about a 1.8% increase in density. For at least some embodiments of GTE 16, for every percentage of air density increase, the power output efficiency of the GTE 16 may increase by about 2.2%.

As shown in FIG. 8, in some embodiments, the first pressure control chamber 180 of the pressure control assembly 172 may be in fluid communication with a filtration chamber 84 of a filtration housing 78 via at least one outlet 184 of the air conditioning assembly 172. In some embodiments, the pressure control assembly 172 may further include one or more drift eliminators and/or coalescer pads configured to, for example, reduce the amount of liquid in the air flowing through the pressure control assembly 172.

In some embodiments, the one or more temperature control assemblies 174 may be provided for adjusting the temperature of the airstream passing through the air treatment housing 170 and toward the inlet assembly 18 of the GTE 16, and, in some embodiments, may be positioned or mounted downstream of the pressure control assembly 172. The airstream may enter the one or more temperature control assemblies 174 at a first temperature and exits the one or more temperature control assemblies 174 a second temperature, for example, as a second temperature lower than the first temperature. In some embodiments, the one or more temperature control assemblies 174 may include, for example, one or more chillers and/or other devices (e.g., air conditioning units) configured to reduce the temperature of the air flowing through the one or more temperature control assemblies 174. In some embodiments, the specific form of the one or more temperature control assemblies 174 may be tailored based, at least in part, on the configuration of the GTE 16, for example.

In some embodiments, the one or more temperature control assemblies 174 may include one or more chiller assemblies 186. For example, the one or more chiller assemblies 186 may include an arrangement of condenser coils 188 disposed in the air treatment housing 170 and configured to at least partially span the width of the air treatment housing 170, such that, for example, the airstream passes through and/or around the condenser coils 188 to reduce the temperature of the airstream that is directed downstream toward the inlet assembly 18 of the GTE 16. The condenser coils 188 may be in fluid communication with a source of pressurized chilled refrigerant. The refrigerant may be any conventional refrigerant, such as, for example, R22, R410a, and/or similar refrigerants. In some embodiments, the refrigerant may be cooled to about 45 degrees F., although the refrigerant may be cooled to other desired temperature based at least partially on the operating conditions of the hydraulic fracturing unit 12 and/or the GTE 16.

It is contemplated that the one or more temperature control assemblies 174 may decrease the temperature of the airstream entering the inlet assembly 18 of the GTE 16 to increase the efficiency and/or power output of the GTE 16. For example, the one or more temperature control assemblies 174 may decrease a temperature of the airstream by an amount ranging from about 2 degrees F. to about 20 degrees F., for example, from about 5 degrees F. and about 10 degrees F. In some applications, increasing the efficiency and/or the power output of the GTE 16 may result in more efficient operations. For example, in a hydraulic fracturing operation including multiple hydraulic fracturing units 12, each operating a GTE 16 to supply power to drive respective hydraulic fracturing pumps 20, such increases in efficiency and/or power output may facilitate reducing the number the GTEs 16 and/or hydraulic fracturing units being operated, while still providing sufficient power to achieve or exceed desired fracturing fluid pressures and/or flow rates for completion of the hydraulic fracturing operation.

In some embodiments, in elevational cross-sectional view, the condenser coils 188 of the chiller assemblies 186 may have a substantially planar shape, may be W-shaped, V-shaped, or other geometric shapes. The chiller assemblies 186 further may be configured to provide a source of pressurized and/or chilled refrigerant. For example, the chiller assemblies 186 may include a one or more compressors 190 incorporated into a refrigeration cycle and configured to supply pressurized and/or chilled refrigerant to the condenser coils 188. The one or more compressors 190 may include one or more of the following types of compressors: a reciprocating compressor, a scroll compressor, a screw compressor, a rotary compressor, a centrifugal compressor, and/or other known compressor types suitable for providing compressed refrigerant. In some embodiments, the source of pressurized chilled supply may be provided by one or more chill lines carrying pressurized refrigerant, for example, that may be routed through and/or around a cooling source, such as, for example, at least one gas source in liquid form.

In some embodiments, the condenser coils 188 may be placed in an existing radiator package, for example, associated with the hydraulic fracturing unit 12 and/or the hydraulic fracturing operation, where lube coolers and/or engine coolers for the GTE 16 are housed. In some embodiments, the condenser coils 188 may be packaged along with the one or more compressors 190 and an expansion valve of a refrigeration cycle system.

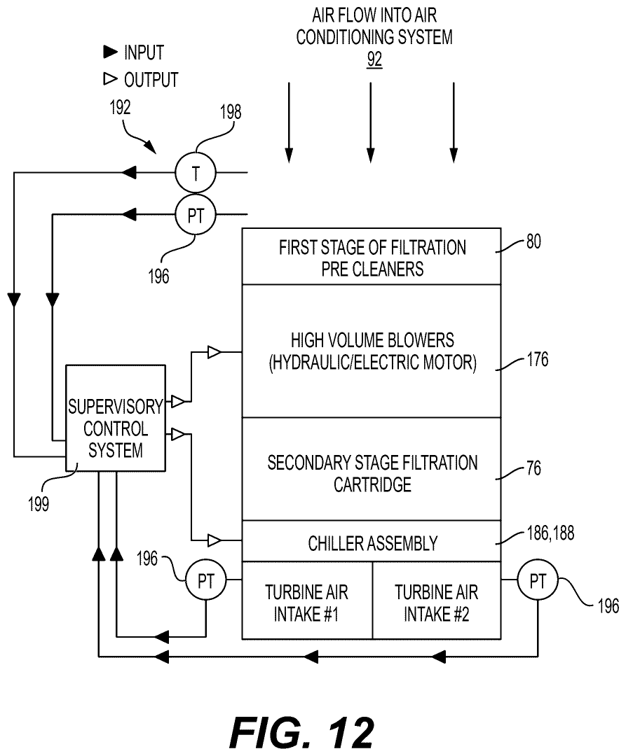

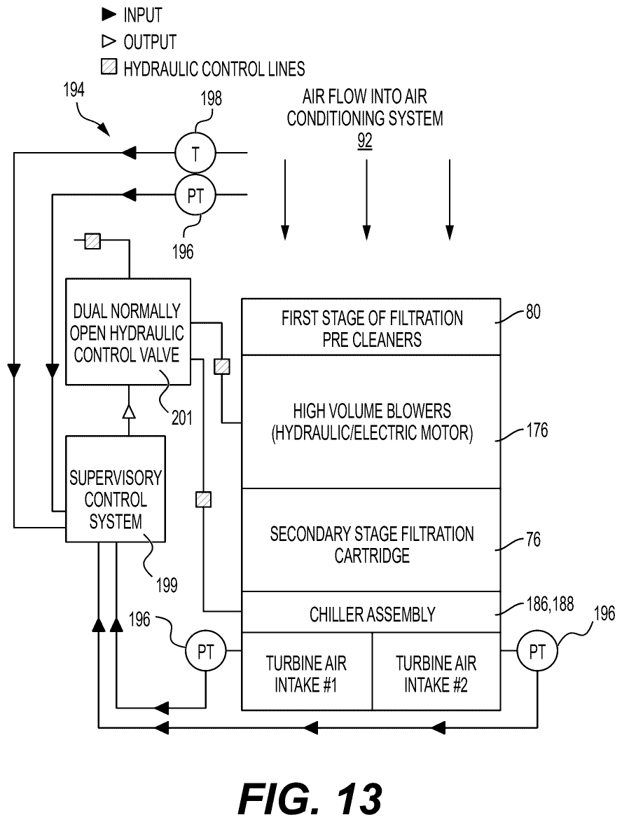

FIG. 12 and FIG. 13 are schematic diagrams of an example electrical assembly 192 and an example hydraulic assembly 194, respectively, for operating examples of intake air treatment assemblies 14, according to embodiments of the disclosure. For example, in some embodiments, it is contemplated that the pressure control assembly 172 and/or one or more of the temperature control assemblies 174 may not be operated at a constant speed or power output. For example, during a cold day with low humidity and/or at a low elevation, the intake air treatment assembly 14 may only utilize the one or more pre-cleaners 80 and/or the one or more filters 86 of the filtration assembly 76. In some embodiments, the one or more blower fans 176 may be selectively engaged to increase the likelihood or ensure that any pressure drop across the pre-cleaners 80 and/or filters 86 is within the GTE manufacturer's guidelines, and/or that one or more of the blower fans 176 will not be run at the respective blower fan's flowrate rating (e.g., cubic feet per minute), nor will one or more of the temperature control assemblies 174 attempt to reduce the temperature of the air to an unnecessarily low temperature. For example, as shown in FIGS. 12 and 13, the pressure control assembly 172 and at least one temperature control assembly 174 may be selectively controlled via proportional motor control that may be operatively configured to function through a combination of the use of programmable VFDs, a PLC control system, an instrumentation, and/or a hydraulic control system.

In some embodiments, ISO conditions of 59 degrees F., 14.696 pounds per square inch atmospheric pressure, at sea level, and 60% relative humidity, may be used as baseline operating levels for control of the intake air treatment assembly 14, for example, because these parameters may often be used to rate a GTE for service.

As shown in FIG. 12, in some embodiments, the intake air treatment assembly 14 may be configured to use one or more signals from one or more sensors, such as atmospheric pressure sensors 196 and/or temperature sensors 198 to facilitate monitoring of, for example, air density through the data inputs and calculating, at a desired sample rate, the density in reference to temperature change and elevation change. It is contemplated that the pressure drop through the one or more pre-cleaners 80 and/or the one or more filters 86 may be monitored via two or more pressure sensors 196, which may be positioned, for example, at the intake of the one or more pre-cleaners 80 and/or filters 86, and at the intake assembly 18 of the GTE 16. A pressure differential between the pressure sensors 196 of the different locations may facilitate the intake air treatment assembly 14 to control operation of the one or more blower fans 176, for example, so that they operate at a desired speed to reduce, mitigate, or overcome any sensed pressure drop between the sensor locations.

In some embodiments, the intake air treatment assembly 14 may include a supervisory control system 199, which may be used to at least partially control operation of the pressure control assembly 172 and/or the temperature control assembly 174. In the event there is a loss of one or more control signals from the supervisory control system 199, the one or more chiller assemblies 186 and/or the one or more blower fans 176 may be configured to automatically revert to operation at maximum output as a failsafe and/or to ensure that operation of the GTE 16 is not ceased. During operation, the pressure sensors 196 and/or the temperature sensors 198 may be configured to provide continuous or intermittent feedback to the supervisory control system 199. In some embodiments, during normal operation, the supervisory control system 199 may be configured to detect a deficiency of the inlet airstream, such as a high temperature and/or a pressure drop, and may further be configured to generate one or more control signals to the blower fan motors and/or the one or more temperature control assemblies, for example, to condition the airstream to mitigate or overcome the environmental losses. In some embodiments, the supervisory control system 199 may include, for example, a PLC, micro-controllers, computer-based controllers, and the like as will be understood by those skilled in the art.

FIG. 13 schematically illustrates an example use of hydraulic power to operate one or more hydraulic motors connected to the one or more blower fans 176 (e.g., if hydraulically powered blower fans are used), and hydraulically-powered fans connected to the one or more temperature control assemblies 174 (e.g., if used). In some such embodiments, one or more proportional hydraulic control valves 201 may be provided and configured to receive operational input from the supervisory control system 199, for example, for selective operation of a spool to control the supply of hydraulic fluid to the temperature control system 174.

Having now described some illustrative embodiments of the disclosure, it should be apparent to those skilled in the art that the foregoing is merely illustrative and not limiting, having been presented by way of example only. Numerous modifications and other embodiments are within the scope of one of ordinary skill in the art and are contemplated as falling within the scope of the disclosure. In particular, although many of the examples presented herein involve specific combinations of method acts or system elements, it should be understood that those acts and those elements may be combined in other ways to accomplish the same objectives. Those skilled in the art should appreciate that the parameters and configurations described herein are exemplary and that actual parameters and/or configurations will depend on the specific application in which the systems, methods, and/or aspects or techniques of the disclosure are used. Those skilled in the art should also recognize or be able to ascertain, using no more than routine experimentation, equivalents to the specific embodiments of the disclosure. It is, therefore, to be understood that the embodiments described herein are presented by way of example only and that, within the scope of any appended claims and equivalents thereto, the disclosure may be practiced other than as specifically described.

This application is a continuation of U.S. Non-Provisional application Ser. No. 17/989,601, filed Nov. 17, 2022, titled “SYSTEMS, ASSEMBLIES, AND METHODS TO ENHANCE INTAKE AIR FLOW TO A GAS TURBINE ENGINE OF A HYDRAULIC FRACTURING UNIT”, which is a continuation-in-part of U.S. Non-Provisional application Ser. No. 17/954,118, filed Sep. 27, 2022, titled “MOBILE GAS TURBINE INLET AIR CONDITIONING SYSTEM AND ASSOCIATED METHODS,” which is a continuation of U.S. Non-Provisional application Ser. No. 17/403,373, filed Aug. 16, 2021, titled “MOBILE GAS TURBINE INLET AIR CONDITIONING SYSTEM AND ASSOCIATED METHODS,” which is a continuation of U.S. Non-Provisional application Ser. No. 17/326,711, filed May 21, 2021, titled “MOBILE GAS TURBINE INLET AIR CONDITIONING SYSTEM AND ASSOCIATED METHODS,” now U.S. Pat. No. 11,156,159, issued Oct. 26, 2021, which is a continuation U.S. Non-Provisional application Ser. No. 17/213,802, filed Mar. 26, 2021, titled “MOBILE GAS TURBINE INLET AIR CONDITIONING SYSTEM AND ASSOCIATED METHODS,” now U.S. Pat. No. 11,060,455, issued Jul. 13, 2021, which is a continuation of U.S. Non-Provisional application Ser. No. 16/948,289, filed Sep. 11, 2020, titled “MOBILE GAS TURBINE INLET AIR CONDITIONING SYSTEM AND ASSOCIATED METHODS,” now U.S. Pat. No. 11,002,189, issued May 11, 2021, which claims priority to and the benefit of U.S. Provisional Application No. 62/704,565, filed May 15, 2020, titled “MOBILE GAS TURBINE INLET AIR CONDITIONING SYSTEM AND ASSOCIATED METHODS,” and U.S. Provisional Application No. 62/900,291, filed Sep. 13, 2019, titled “MOBILE GAS TURBINE INLET AIR CONDITIONING SYSTEM,” the disclosures of which are incorporated herein by reference in their entireties.

The scope of the present disclosure shall be construed to cover various modifications, combinations, additions, alterations, etc., above and to the above-described embodiments, which shall be considered to be within the scope of this disclosure. Accordingly, various features and characteristics as discussed herein may be selectively interchanged and applied to other illustrated and non-illustrated embodiment, and numerous variations, modifications, and additions further may be made thereto without departing from the spirit and scope of the present disclosure as set forth in the appended claims.

1. (canceled)

2. An intake air treatment assembly to enhance the efficiency of operation of a gas turbine engine including an inlet assembly positioned to supply intake air to the gas turbine engine, the intake air treatment assembly comprising:
a turbine housing configured to at least partially enclose the gas turbine engine and the inlet assembly and positioned to facilitate supply of intake air to the inlet assembly of the gas turbine engine;
a filtration assembly connected to the turbine housing and positioned to provide a flow path to supply at least partially filtered intake air to the inlet assembly of the gas turbine engine, the filtration assembly comprising:
a pre-cleaner positioned to receive ambient air drawn into the filtration assembly via operation of the gas turbine engine and comprising one or more inertial separators configured to separate a first portion of one or more of particles or liquid from the ambient air, thereby to provide at least partially filtered intake air,
wherein the one or more inertial separators comprise:
an air flow tube having a proximal end connected to the exterior panel, extending toward the interior panel, and terminating at a distal end, the air flow tube defining an interior cross-sectional area; and
a diverter connected to the air flow tube and positioned to cause ambient air entering the air flow tube to swirl as the ambient air flows from the proximal end of the air flow tube to the distal end of the air flow tube.

3. The intake air treatment assembly of claim 2, wherein the pre-cleaner comprises: an exterior panel facing outward from the filtration assembly; and an interior panel opposite the exterior panel and facing inward toward an interior of the filtration assembly, the one or more inertial separators extending between the exterior panel and the interior panel.

4. The intake air treatment assembly of claim 3, wherein the one or more inertial separators further comprise a separator tube connected to the interior panel and extending from the interior panel toward the distal end of the air flow tube, the separator tube having an exterior cross-sectional area smaller than the interior cross-sectional area of the air flow tube.

5. The intake air treatment assembly of claim 4, wherein the separator tube is positioned relative to the distal end of the air flow tube to provide: a first separator flow path for the at least partially filtered intake air to exit the pre-cleaner through an interior passage of the separator tube; and a second separator flow path for the first portion of the one or more of particles or liquid to be separated from the ambient air entering the inertial separator, the second separator flow path passing between an exterior surface of the separator tube and an interior surface of the air flow tube.

6. The intake air treatment assembly of claim 4, wherein the diverter comprises one or more stator blades presenting one or more curved surfaces to cause the ambient air entering the air flow tube to swirl as the ambient air passes the one or more stator blades and flows from the proximal end of the air flow tube to the distal end of the air flow tube.

7. The intake air treatment assembly of claim 4, wherein the interior panel at least partially defines an interior hole, and the separator tube is connected to the interior panel such that an interior passage of the separator tube provides a first separator flow path for the at least partially filtered intake air to exit the inertial separator through the interior passage of the separator tube and the interior hole of the interior panel.

8. The intake air treatment assembly of claim 7, wherein: the exterior panel and the interior panel at least partially define a separator cavity therebetween; and the air flow tube is connected to an exterior surface of the separator tube and at least partially defines a second separator flow path for the first portion of the one or more of particles or liquid to be separated from the ambient air entering the inertial separator, the second separator flow path being positioned to deposit the first portion of the one or more of particles or liquid into the separator cavity.

9. The intake air treatment assembly of claim 8, wherein the distal end of the air flow tube terminates between the exterior panel and the interior panel, thereby at least partially defining the second separator flow path.

10. The intake air treatment assembly of claim 4, wherein one or more of an interior passage of the air flow tube, an interior passage of the separator tube, or an exterior surface of the separator tube has a substantially circular cross-sectional shape.

11. The intake air treatment assembly of claim 2, further comprising a pre-cleaner collector connected to the pre-cleaner and positioned to receive the first portion of the one or more of particles or liquid separated from the ambient air.

12. The intake air treatment assembly of claim 11, further comprising one or more filters positioned in the flow path downstream of the pre-cleaner and configured to separate a second portion of the one or more of particles or liquid from the at least partially filtered intake air, wherein the one or more filters comprise one or more of a pre-filter or a final filter.

13. The intake air treatment assembly of claim 11, wherein the one or more filters comprise the pre-filter downstream of the pre-cleaner and the final filter downstream of the pre-filter.

14. The intake air treatment assembly of claim 11, wherein the one or more of a pre-filter or a final filter comprises one or more of a medium-efficiency intermediate filter or a high-efficiency final filter.

15. The intake air treatment assembly of claim 11, wherein the one or more of a pre-filter or a final filter comprises one or more of a cartridge-type pre-filter or a bag-type pre-filter.

16. The intake air treatment assembly of claim 2, wherein the pre-cleaner comprises a plurality of inertial separators.

17. The intake air treatment assembly of claim 16, wherein: the pre-cleaner comprises an exterior panel facing outward from the filtration assembly and an interior panel opposite the exterior panel and facing inward toward an interior of the filtration assembly; and one or more of the exterior panel or the interior panel at least partially defines an upper end and a lower end, and the plurality of inertial separators are arranged in groups extending diagonally between the upper end and the lower end of the pre-cleaner.

18. The intake air treatment assembly of claim 11, wherein the pre-cleaner comprises one or more flanges extending outward from a perimeter of the pre-cleaner, and the pre-cleaner is connected to the filtration assembly via the one or more flanges.

19. The intake air treatment assembly of claim 11, wherein the filtration assembly comprises a plurality of pre-cleaners.

20. A hydraulic fracturing unit to enhance flow of fracturing fluid into a wellhead during a high-pressure fracturing operation, the hydraulic fracturing unit comprising:
a chassis having a longitudinal chassis axis and a width perpendicular to the longitudinal chassis axis;
a gas turbine engine supported by the chassis;
an inlet assembly connected to the gas turbine engine to supply intake air to the gas turbine engine;
a hydraulic fracturing pump connected to the gas turbine engine; and
an intake air treatment assembly associated with the intake assembly to enhance the efficiency of operation of the gas turbine engine, the intake air treatment assembly comprising:
a turbine housing at least partially enclosing the gas turbine engine and the inlet assembly and positioned to facilitate supply of intake air to the inlet assembly of the gas turbine engine;
a filtration assembly connected to the turbine housing and positioned to provide a flow path to supply at least partially filtered intake air to the inlet assembly, the filtration assembly comprising:
a pre-cleaner positioned to receive ambient air drawn into the filtration assembly via operation of the gas turbine engine and comprising one or more inertial separators configured to separate a first portion of one or more of particles or liquid from the ambient air, thereby to provide at least partially filtered intake air,
wherein the one or more inertial separators comprise:
an air flow tube having a proximal end connected to the exterior panel, extending toward the interior panel, and terminating at a distal end, the air flow tube defining an interior cross-sectional area; and
a diverter connected to the air flow tube and positioned to cause ambient air entering the air flow tube to swirl as the ambient air flows from the proximal end of the air flow tube to the distal end of the air flow tube.

21. The hydraulic fracturing unit of claim 20, wherein the one or more inertial separators further comprise a separator tube connected to the interior panel and extending from the interior panel toward the distal end of the air flow tube, the separator tube having an exterior cross-sectional area smaller than the interior cross-sectional area of the air flow tube.
